(19) United States
(12) Patent Application Publication
(10) Pub. No.: US 2026/0067051 A1
(43) Pub. Date: Mar. 5, 2026

(54) RADIO LINK CONTROL STATUS REPORT TIMING SELECTION

(71) Applicant: QUALCOMM Incorporated, San Diego, CA (US)

(72) Inventors: Sherif ELAZZOUNI, San Diego, CA (US); Sitaramanjaneyulu KANAMARLAPUDI, San Diego, CA (US); Gavin Bernard HORN, La Jolla, CA (US); Ozcan OZTURK, San Diego, CA (US)

(21) Appl. No.: 18/821,157

(22) Filed: Aug. 30, 2024

(51) Int. Cl. H04L 5/00

(52) U.S. Cl. CPC H04L 5/0091

(57) ABSTRACT

Methods, systems, and devices for wireless communications are described. A wireless device may determine a dynamic expiration value for a timer (e.g., a radio link control (RLC) status protocol data unit (PDU) retransmission timer), determine one or more event triggers for retransmitting a status PDU, or both, and may retransmit an RLC status PDU based on the expiration value, the one or more event triggers, or both. The UE may determine the second expiration time, the one or more event triggers, or both, based on one or more RLC or hybrid automatic repeat request (HARQ) parameters, one or more predictions associated with RLC PDUs, or both, where a machine learning (ML) model may generate the one or more predictions, the UE may be configured with one or more parameters and key performance indicators (KPIs) for determining the second expiration value, the one or more event triggers, or both.

### FIELD OF TECHNOLOGY

The following relates to wireless communications, including radio link control (RLC) status report timing selection.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method by an apparatus is described. The method may include sending a first status protocol data unit (PDU) associated with a radio link control entity of a user equipment (UE), starting, in response to sending the first status PDU, a timer prohibiting one or more additional status PDUs associated with the radio link control entity, where the timer has a first expiration time, determining a second expiration time for the timer, one or more event triggers, or both, based on one or more predictions for sending the one or more additional status PDUs, and sending a second status PDU associated with the radio link control entity in response to the timer satisfying the second expiration time, an occurrence of the one or more event triggers, or both.

An apparatus is described. The apparatus may include one or more memories storing processor executable code, and one or more processors coupled with the one or more memories. The one or more processors may individually or collectively be operable to execute the code to cause the apparatus to send a first status PDU associated with a radio link control entity of the UE, start, in response to sending the first status PDU, a timer prohibiting one or more additional status PDUs associated with the radio link control entity, where the timer has a first expiration time, determine a second expiration time for the timer, one or more event triggers, or both, based on one or more predictions for sending the one or more additional status PDUs, and send a second status PDU associated with the radio link control entity in response to the timer satisfying the second expiration time, an occurrence of the one or more event triggers, or both.

Another apparatus is described. The apparatus may include means for sending a first status PDU associated with a radio link control entity of the UE, means for starting, in response to sending the first status PDU, a timer prohibiting one or more additional status PDUs associated with the radio link control entity, where the timer has a first expiration time, means for determining a second expiration time for the timer, one or more event triggers, or both, based on one or more predictions for sending the one or more additional status PDUs, and means for sending a second status PDU associated with the radio link control entity in response to the timer satisfying the second expiration time, an occurrence of the one or more event triggers, or both.

A non-transitory computer-readable medium storing code is described. The code may include instructions executable by one or more processors to send a first status PDU associated with a radio link control entity of the UE, start, in response to sending the first status PDU, a timer prohibiting one or more additional status PDUs associated with the radio link control entity, where the timer has a first expiration time, determine a second expiration time for the timer, one or more event triggers, or both, based on one or more predictions for sending the one or more additional status PDUs, and send a second status PDU associated with the radio link control entity in response to the timer satisfying the second expiration time, an occurrence of the one or more event triggers, or both.

Some examples of the method, apparatus, and non-transitory computer-readable medium described herein may further include operations, features, means, or instructions for transmitting an indication of the second expiration time based on determining the second expiration time.

In some examples of the method, apparatus, and non-transitory computer-readable medium described herein, the second status PDU includes the indication of the second expiration time.

In some examples of the method, apparatus, and non-transitory computer-readable medium described herein, the indication of the second expiration time includes one or more recommended values corresponding to the second expiration time and the one or more recommended values may be based on the one or more predictions.

In some examples of the method, apparatus, and non-transitory computer-readable medium described herein, determining the second expiration time may include operations, features, means, or instructions for selecting a value of the second expiration time based on a range of configured values, where the indication of the second expiration time includes an indication of the selected value.

In some examples of the method, apparatus, and non-transitory computer-readable medium described herein, determining the second expiration time may include operations, features, means, or instructions for determining a value of the second expiration time based on a quantity of retransmissions associated with one or more PDUs, a latency parameter, the occurrence of the one or more event triggers, or any combination thereof.

In some examples of the method, apparatus, and non-transitory computer-readable medium described herein, transmitting the indication of the second expiration time may include operations, features, means, or instructions for transmitting a control message including the indication of the second expiration time, where the control message includes a medium access control (MAC) control element, a radio link control (RLC) control PDU, a radio resource control message, or any combination thereof.

Some examples of the method, apparatus, and non-transitory computer-readable medium described herein may further include operations, features, means, or instructions for restarting the timer based on sending the second status PDU in response to the occurrence of the one or more event triggers.

In some examples of the method, apparatus, and non-transitory computer-readable medium described herein, the one or more event triggers may be based on a predicted loss of a hybrid automatic repeat request message.

In some examples of the method, apparatus, and non-transitory computer-readable medium described herein, the one or more event triggers may be determined based on a transport block size associated with one or more messages, one or more component carriers used for transmitting the one or more messages, a predicted payload of the one or more messages, a latency parameter associated with the one or more messages, or any combination thereof.

In some examples of the method, apparatus, and non-transitory computer-readable medium described herein, the one or more event triggers may be associated with a change in performance of one or more links and sending the second status PDU in response to the occurrence of the one or more event triggers includes an indication to use a link that may be different than the one or more links based on the change in the performance.

Some examples of the method, apparatus, and non-transitory computer-readable medium described herein may further include operations, features, means, or instructions for storing a set of information associated with sending the one or more additional status PDUs in response to the timer satisfying the second expiration time, the occurrence of the one or more event triggers, or both, where determining the second expiration time, the one or more event triggers, or both, based on the one or more predictions may be in accordance with the set of information.

In some examples of the method, apparatus, and non-transitory computer-readable medium described herein, the set of information includes respective values of expiration times for the timer over a first duration, respective event triggers of the one or more event triggers over a second duration, one or more sequence numbers of one or more radio link control PDUs corresponding to a quantity of retransmissions, the one or more sequence numbers of one or more radio link control PDUs corresponding to a latency, information associated with a quantity of duplicate radio link control PDUs, information associated with a quantity of duplicate packet data convergence protocol (PDCP) PDUs, or any combination thereof.

Some examples of the method, apparatus, and non-transitory computer-readable medium described herein may further include operations, features, means, or instructions for transmitting a report indicating at least a portion of the set of information based on storing the set of information associated with sending the one or more additional status PDUs.

Some examples of the method, apparatus, and non-transitory computer-readable medium described herein may further include operations, features, means, or instructions for sending the second status PDU in response to the timer satisfying the second expiration time, the occurrence of the one or more event triggers, or both, may be based on a machine learning model satisfying one or more key performance indicators and the one or more key performance indicators may be associated with a set of statistics indicating a latency for processing of a set of PDUs, a quantity of status PDUs that satisfy a threshold, or any combination thereof.

Some examples of the method, apparatus, and non-transitory computer-readable medium described herein may further include operations, features, means, or instructions for transmitting a capability message indicating a capability to determine the second expiration time, the one or more event triggers, or both, based on the one or more predictions.

In some examples of the method, apparatus, and non-transitory computer-readable medium described herein, the capability message includes an indication of an accuracy of a machine learning model for generating the one or more predictions, an indication of one or more key performance indicator associated with the machine learning model for generating the one or more predictions, or any combination thereof and the one or more key performance indicators indicate one or more throughput parameters supported by the UE, one or more latency parameters supported by the UE, one or more communication performance targets supported by the UE, or any combination thereof.

Some examples of the method, apparatus, and non-transitory computer-readable medium described herein may further include operations, features, means, or instructions for receiving a control message indicating a configuration of one or more parameters associated with sending the second status PDU in response to the timer satisfying the second expiration time, the occurrence of the one or more event triggers, or both, where sending the second status PDU in response to the timer satisfying the second expiration time, the occurrence of the one or more event triggers, or both, may be in accordance with the configuration.

In some examples of the method, apparatus, and non-transitory computer-readable medium described herein, the one or more parameters include a minimum value of the timer, a maximum value of the timer, a range of values for the timer corresponding to respective status PDUs of the one or more additional status PDUs, an indication of whether a machine learning model may be enabled for the one or more predictions, an indication of whether the machine learning model may be enabled for one or more quality of service (QoS) flows, an indication of whether sending the one or more additional status PDUs in response to the one or more event triggers may be enabled, an indication of respective event triggers of the one or more event triggers for sending the one or more additional status PDUs, one or more key performance indicators, a reporting threshold associated with the one or more additional status PDUs, or any combination thereof.

Some examples of the method, apparatus, and non-transitory computer-readable medium described herein may further include operations, features, means, or instructions for determining that sending the second status PDU fails to satisfy one or more key performance indicators, where one or more status PDUs sent after the second status PDU may be sent in accordance with the first expiration time of the timer.

Some examples of the method, apparatus, and non-transitory computer-readable medium described herein may further include operations, features, means, or instructions for transmitting a message indicating that sending the second status PDU failed to satisfy the one or more key performance indicators based on determining that sending the second status PDU failed to satisfy the one or more key performance indicators.

Some examples of the method, apparatus, and non-transitory computer-readable medium described herein may further include operations, features, means, or instructions for disabling the one or more predictions for determining the second expiration time for the timer, the one or more event triggers, or both, based on determining that sending the second status PDU failed to satisfy the one or more key performance indicators.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports radio link control (RLC) status report timing selection in accordance with one or more aspects of the present disclosure.

FIG. 2 shows an example of a wireless communications system that supports RLC status report timing selection in accordance with one or more aspects of the present disclosure.

FIG. 3 shows an example of a process flow that supports RLC status report timing selection in accordance with one or more aspects of the present disclosure.

FIG. 4 shows an example of a machine learning (ML) architecture that supports RLC status report timing selection in accordance with one or more aspects of the present disclosure.

FIGS. 5 and 6 show examples of block diagrams of a user equipment (UE) that supports RLC status report timing selection in accordance with one or more aspects of the present disclosure.

FIGS. 7 through 13 show examples of process flows that supports RLC status report timing selection in accordance with one or more aspects of the present disclosure.

FIG. 14 shows an illustrative block diagram of an example ML architecture that may be used for wireless communications in accordance with one or more aspects of the present disclosure.

FIGS. 15 and 16 show block diagrams of devices that support RLC status report timing selection in accordance with one or more aspects of the present disclosure.

FIG. 17 shows a block diagram of a communications manager that supports RLC status report timing selection in accordance with one or more aspects of the present disclosure.

FIG. 18 shows a diagram of a system including a device that supports RLC status report timing selection in accordance with one or more aspects of the present disclosure.

FIG. 19 shows a flowchart illustrating methods that support RLC status report timing selection in accordance with one or more aspects of the present disclosure.

### DETAILED DESCRIPTION

Some wireless devices (e.g., a wireless communications device, a user equipment (UE), a network entity) may receive a wireless signal and process data associated with the wireless signal through a plurality of protocol layers, including a radio link control (RLC) layer (e.g., which may include an RLC entity). The data may include one or more protocol data units (PDUs), and each protocol layer may process (e.g., decode) at least a portion of the one or more protocol data units (PDUs) and send the processed one or more PDUs (e.g., via service data units (SDUs)) to a subsequent protocol layer for further processing (e.g., until the wireless device has decoded all of the information contained in the data). In some cases, the RLC entity (e.g., an acknowledgment mode (AM) RLC entity) may send (e.g., deliver, output), from the RLC layer, an RLC status PDU (e.g., a status PDU), which the wireless device may transmit to another wireless device via a status report as feedback. For example, the wireless device may send the status PDU in response to receiving polling signaling from the other wireless device, detecting a reception failure of a PDU at the RLC entity (e.g., missing RLC PDUs, an RLC hole), or both.

In response to sending the status PDU, the RLC entity of the wireless device may start (e.g., initiate, instantiate) a timer (e.g., a t-StatusProhibit timer, an RLC status PDU retransmission timer) that prohibits transmission of a second status PDU until the expiration of the timer (e.g., until a count of the timer satisfies an expiration value) to reduce wireless signaling traffic. For example, the wireless device may not receive a response to the status PDU for the duration of the timer, and may transmit a second status PDU after the expiration of the timer. However, in some examples, waiting for the expiration of the timer before retransmitting another status PDU may cause processing latency at the wireless device. For example, if the amount of time before the time expires is too large, the wireless device may fail to satisfy latency constraints (e.g., packet delay budget) for one or more PDUs in the RLC entity (e.g., because another status PDU may not be sent until the time expires). Thus, a method of reducing latency associated with the timer while maintaining efficient wireless signaling traffic may be beneficial.

According to techniques described herein, a wireless communication device (e.g., a UE, a network entity) may dynamically select a timing for outputting an RLC status PDU (e.g., prior to the expiration of the timer). For example, the wireless communication device may determine a dynamic (e.g., second) expiration value for the timer (e.g., the t-StatusProhibit timer), determine one or more event triggers for retransmitting a status PDU, or both, based on the output of a machine learning (ML) model (e.g., an artificial intelligence (AI)/ML model or functionality). For example, the wireless communication device may start the timer in response to outputting a first status PDU from an RLC entity of the wireless communication device, where the timer may have a first expiration time (e.g., the wireless communication device may initially set the timer to expire at a first expiration time). The wireless communication device may determine the second expiration time, the one or more event triggers, or both, and an RLC entity of the wireless communication device may send a second status PDU (e.g., send a second instance of a status PDU from the RLC entity, send a second status PDU) based on the timer satisfying the second expiration time, based on an occurrence of the one or more event triggers, or both.

The wireless communication device may determine the second expiration time, the one or more event triggers, or both, based on one or more RLC or hybrid automatic repeat request (HARQ) parameters, one or more predictions associated with RLC PDUs, or both, where the ML model may generate the one or more predictions. For example, the one or more predictions may include a predicted loss of a HARQ message, a predicted RLC loss or failure (e.g., not receiving or failing to decode an RLC PDU, RLC link quality degradation), a predicted payload of one or more messages (e.g., of one or more missing RLC PDUs), a predicted retransmission delay of one or more PDUs (e.g., a predicted time for the wireless communication device to receive a retransmission of missing RLC PDUs in response to the first status PDU), or any combination thereof. In some cases, the RLC or HARQ parameters used to determine the second expiration time may include a quantity of retransmissions of one or more messages (e.g., RLC PDUs, status reports, other signaling), a latency parameter associated with one or more messages, or the timing of the occurrence of one or more previous event triggers. In some cases, the RLC or HARQ parameters used to determine the one or more event triggers may include a transport block size associated with the one or more messages, one or more component carriers used for transmitting the one or more messages, the predicted payload of the one or more messages, the latency parameter of the one or more messages, or any combination thereof.

Additionally, or alternatively, the wireless communication device may be configured with one or more parameters and key performance indicators (KPIs) for determining the second expiration value, the one or more event triggers, or both. For example, the KPIs may indicate a threshold accuracy (e.g., a minimum accuracy) of the outputs of the ML model, a threshold quantity (e.g., a maximum quantity) of duplicate RLC PDUs received at the wireless communication device due to dynamically sending the status PDU, or both. In some examples, if the wireless communication device is not satisfying the one or more KPIs, the wireless communication device may perform a fallback procedure, which may include transmitting a KPI violation message, disabling ML model or predictive functions associated with the RLC status PDUs, or both.

Aspects of the disclosure are initially described in the context of wireless communications systems. Aspects of the disclosure are also described in the context of process flows, ML architectures and block diagrams. Aspects of the disclosure are further illustrated by and described with reference to apparatus diagrams, system diagrams, and flowcharts that relate to RLC status report timing selection. In some examples, the term “PDU” may be used herein to refer to an RLC PDU, and the term “status PDU” may be used to refer to an RLC status PDU.

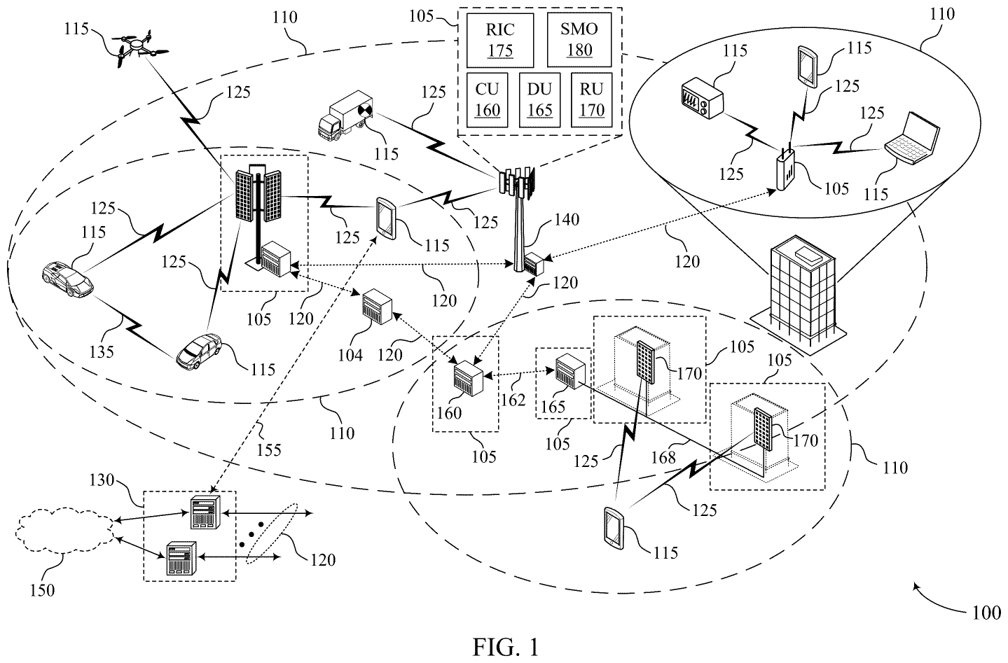

FIG. 1 shows an example of a wireless communications system 100 that supports RLC status report timing selection in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., RLC layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

In some examples, a UE 115 may support AI and/or ML models and/or functionalities, which the UE 115 may use to perform various wireless communications procedures (e.g., CSI prediction, beam selection, and/or beam prediction, among other examples). In such cases, the UE 115 may generate inference data using one or more AI/ML models/functionalities. Additionally, or alternatively, the UE 115 may perform life cycle management (LCM) operations for a given AI/ML model and/or functionality (e.g., model or functionality selection, activation, deactivation, switching, and fallback, among other examples) based on one or more AI/ML models/functionalities. In some aspects, LCM may be model-based or functionality-based LCM procedures. As described herein, an AI functionality or AI model may be referred to as an ML functionality or ML model, or vice versa. That is, the terms “AI” and “ML” may, in some examples, be used interchangeably to refer to similar technologies, models, functions, algorithms, or any combination thereof. Similarly, the terms “model” and “functionality” may be used interchangeably. In some examples, ML operations may be considered a subset of AI operations. In any case, aspects of the features described herein may be referred to as AI functionalities, AI functions, AI models, AI services, AI operations, or the like, and such features may be similarly applicable to ML functionalities, ML functions, ML models, ML services, ML operations, or any combination thereof. Thus, reference to “ML” or “AI” may refer to ML, AI, or both, and the terms “AI” or “ML” should not be considered limiting to the scope of the claims or the disclosure.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. HARQ feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

According to techniques described herein, a wireless device (e.g., a UE 115, a network entity 105) may dynamically output an RLC status PDU (e.g., prior to the expiration of an RLC status PDU retransmission timer, t-StatisProhibit). For example, a UE 115 may start a timer in response to outputting a first status PDU from an RLC entity of the UE 115, where the timer may have a first expiration time. The UE 115 may determine the second expiration time, the one or more event triggers, or both, and an RLC entity of the UE may send a second status PDU based on the timer satisfying the second expiration time, based on an occurrence of the one or more event triggers, or both.

In some examples, the UE 115 may determine the second expiration time, the one or more event triggers, or both, based on one or more RLC or HARQ parameters, one or more predictions associated with RLC PDUs, or both, where the ML model may generate (e.g., output) the one or more predictions. For example, the one or more predictions may include a predicted loss of a HARQ message, a predicted RLC loss or failure, a predicted payload of one or more messages, a predicted retransmission delay of one or more PDUs, or any combination thereof. In some cases, the RLC or HARQ parameters used to determine the second expiration time may include a quantity of retransmissions of one or more messages, a latency parameter associated with the one or more messages, or the timing of the occurrence of one or more previous event triggers. In some cases, the RLC or HARQ parameters used to determine the one or more event triggers may include a transport block size associated with the one or more messages, one or more component carriers used for transmitting the one or more messages, the predicted payload of the one or more messages, the latency parameter of the one or more messages, or any combination thereof.

Additionally, or alternatively, the UE 115 may be configured with one or more parameters and KPIs for determining the second expiration value, the one or more event triggers, or both. For example, the KPIs may indicate a threshold accuracy of the outputs of the ML model, a threshold quantity of duplicate RLC PDUs received at the UE 115 due to dynamically sending the status PDU, or both. In some examples, if the UE 115 is not satisfying the one or more KPIs, the UE 115 may perform a fallback procedure, which may include transmitting a KPI violation message, disabling ML model or predictive functions associated with the RLC status PDUs, or both.

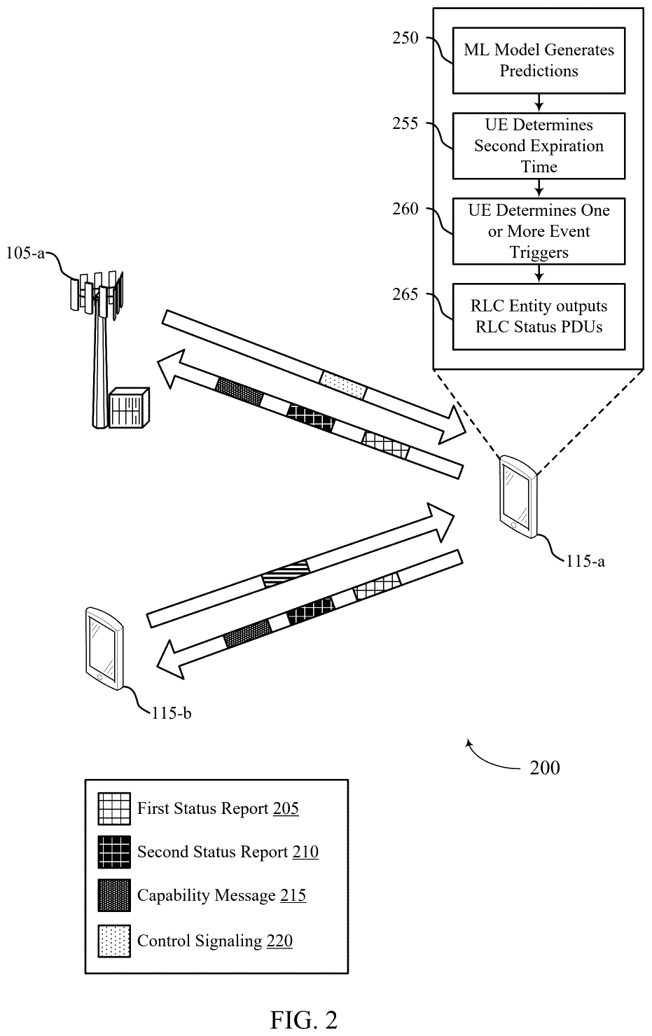

FIG. 2 shows an example of a wireless communications system 200 that supports RLC status report timing selection in accordance with one or more aspects of the present disclosure. In some cases, aspects of the wireless communications system 200 may implement or be implemented by aspects of FIG. 1. For example, the wireless communications system 200 may include UEs 115 (e.g., a UE 115-a, a UE 115-b) and a network entity 105-a, which may be examples of UEs 115 and network entities 105 as described herein with respect to FIG. 1. In some aspects, the UE 115-a may perform one or more communications with the UE 115-b, the network entity 105-a, or both, where communications between the UE 115-a and the network entity 105-a may also be performed between the UE 115-a and the UE 115-b, the UE 115-a and another wireless or network device, or both. Additionally, or alternatively, operations performed by the UE 115-a may be performed by a network entity 105. In some aspects, the UE 115-a may transmit a second status report 210 (e.g., retransmit a first status report 205) that includes a second status PDU (e.g., a copy of a first status PDU included in the first status report 205) based on determining a second expiration time of a timer (e.g., t-StatusProhibit timer), determining one or more event triggers, or both. Although the wireless communications system 200 includes a first status report 205 and the second status report 210, the first status report 205 may refer to any status report transmitted by the UE 115-a, and the second status report 210 may refer to any status report transmitted by the UE 115-a after transmission of the first status report 205.

In some cases, the UE 115-a may include an RLC entity (e.g., an acknowledgment mode (AM) RLC entity) that processes RLC SDUs that are from received signaling or are for inclusion in transmitted signaling. In some cases, the RLC entity may output status PDUs (e.g., RLC status PDUs), which the UE 115-a may transmit to other RLC entities (e.g., peer RLC entities in the UE 115-b, the network entity 105-a), or both via status reports (e.g., such as the first status report 205 and the second status report 210). In some cases, the status PDUs may provide positive or negative acknowledgments associated with RLC SDUs (e.g., or portions of the RLC SDUs, RLC PDUs).

A status PDU may include one or more indications. For example, if the UE 115-a detects an RLC SDU for which no byte segments have been received at the RLC entity, the status PDU may include a NACK_SN, which may be set to the sequence number (SN) of the detected RLC SDU. If the UE 115-a detects a continuous sequence of byte segments of a partly received RLC SDU that have not been received at the RLC entity, the status PDU may include a set of NACK_SNs, including an indication of a first byte segment of the continuous sequence (e.g., SOstart) and an indication of a last byte segment of the continuous sequence (e.g., SOend). If the UE 115-a detects a continuous sequence of RLC SDUs that have not been received at the RLC entity, the status PDU may include a set of NACK_SN and a negative acknowledgment (NACK) range, a pair of SOstart and SOend, or both, and the RLC entity of the UE 115-a may set the ACK_SN to the SN of a next unreceived RLC SDU that is not indicated as missing in the resulting status PDU.

In some cases, the UE 115-a may transmit a status report (e.g., such as the first status report 205) in response to one or more status reporting triggers. For example, the status reporting triggers may include receiving polling from another RLC entity (e.g., the network entity 105-a, the UE 115-b), detection of a reception failure of an RLC PDU (e.g., an AM data (AMD) PDU) at the UE 115-a (e.g., detecting an RLC hole, a missing RLC PDU), or both.

In some cases, the UE 115-a may manage (e.g., start, stop, initiate, terminate, instantiate, destroy) a timer (e.g., t-StatusProhibit) associated with the RLC status PDU. For example, if status reporting at the RLC entity of the UE 115-a has been triggered, the UE 115-a may determine whether the timer is running (e.g., if the timer is actively counting). If the timer is not running, the RLC entity of the UE 115-a may construct a status PDU at a first available transmission opportunity (e.g., as indicated by a protocol layer lower than the RLC layer of the UE 115-a) and submit it to a lower protocol layer for eventual transmission in a status report. If the timer is running, the RLC entity of the UE 115-a may construct a status PDU (e.g., a single status PDU even if status reporting was triggered several times while the timer was running) at the first available transmission opportunity after the timer expires, and may submit it to the lower protocol layer. When the UE 115-a submits the status PDU to the lower protocol layer, the RLC entity of the UE 115-a may start the timer and may assign the timer a first expiration time (e.g., a default expiration time, an initial expiration time).

Thus, in some wireless communications systems, the UE 115-a may not send a second status report 210 (e.g., successive status reports) except after the timer expires. For example, the timer may decrease wireless communication traffic by reducing the transmission of status reports before they may be useful. However, in some cases, waiting for the timer to expire before transmitting the second status report 210 may cause latency at the UE 115-a. For example, situations may occur in which transmitting the second status report before the expiration of the timer may be beneficial and reduce latency. For example, waiting for the first expiration time of the timer may not allow the UE 115-a to account for status failures (e.g., HARQ transmissions that are not communicated correctly), latency parameters for RLC PDUs, UE memory constraints (e.g., a threshold memory for buffered PDUs), lost RLC PDUs, RLC PDU packet delay budget (PDB), or any combination thereof.

In some aspects, the techniques described herein may include the UE 115-a dynamically transmitting the second status report 210 (e.g., without respect to the first expiration time of the timer, prior to the first expiration time). For example, the UE 115-a may use an ML model (e.g., an AI model, and AIML model, an algorithm, implemented at the UE 115-a, the network entity 105-a, or both) to determine (e.g., derive, generate, identify) a time for transmitting the second status report 210. In a first example, the UE 115-a may determine a second expiration time for the timer, and may dynamically set the timer expiration time (e.g., control the timer) to trigger the generation and transmission of the second status report 210 at the second expiration time. In a second example (e.g., in addition to or alternative to the first example), the UE 115-a may determine one or more event triggers (e.g., ad hoc event based status report triggers), the occurrence of which may trigger the generations and transmission of the second status report 210.

In some cases, the ML model may receive one or more inputs (e.g., metadata, timestamps, input data) to generate one or more predictions associated with transmission of the status PDUs. For example, the inputs may include HARQ or RLC parameters and events, such as transmission successes and failures on logical channels, a HARQ state of the UE 115-c, HARQ round trip time (RTT), or any combination thereof. Additionally, or alternatively, the inputs may include estimated RLC loss or failure (e.g., both downlink transmissions and status PDU, due to HARQ NACK-to-positive acknowledgment (ACK) errors), predicted retransmission delay (e.g., a time at which the UE expects to receive a retransmission of RLC PDUs associated with the first status report), a sub-carrier spacing associated with the UE 115-a, transport block sizes of one or more messages, observed latency on RLC retransmissions, internal UE power usage (e.g., or power savings), internal UE memory usage (e.g., or memory savings), properties of one or more communications flows associated with the UE 115-a (e.g., throughput, latency), or any combination thereof.

The inputs may also include one or more logs of data (e.g., data stored at the UE 115-a, the network entity 105-a, or both) associated with prior RLC PDU latencies, prior status reports, or both. For example, the inputs may include a log of expiration times previously determined by the UE (e.g., within a duration or time window), a log of event triggers that triggered previous transmission of a status report (e.g., within the duration or time window), a log of RLC SNs of received RLC PDUs as a function of a quantity of retransmissions used to receive the RLC PDUs or latency in receiving the RLC PDUs, statistics of the ML model (e.g., ML model errors indicated by duplicate reception of RLC PDUs at the RLC entity or PDCP layer of the UE 115-a), or any combination thereof.

Based on the inputs, the ML model may generate (e.g., at 250, output) one or more predictions associated with RLC PDU communication. The one or more predictions may include probabilities (e.g., or predictions) associated with RLC PDU arrival times, including one or more probabilities that a missing RLC PDU will be received (e.g., that an RLC hole will be filled) at the UE 115-a after one or more corresponding potential expiration times of the timer, an expected latency of an RLC SDU (e.g., indicated by SN) and whether the RLC SDU will arrive at the RLC entity of the UE 115-a after the first expiration time of the timer or after another PDB-related threshold, a probability that the latency of the RLC SDU is within a threshold latency range (e.g., less than a maximum threshold latency, greater than a minimum threshold latency, both), a prediction of a latency distribution among RLC PDUs based on all RLC parameters and events, general predictions about RLC PDU arrival time or timer expiration, or any combination thereof. The ML model may generate the outputs in order for the UE 115-a to determine the smallest second expiration time for the timer without causing premature status report transmission (e.g., resulting in duplicate RLC PDU reception at the UE 115-a).

Based on the predictions generated by the ML model (e.g., or one or more predictions made by the UE 115-a based on the probabilities output by the ML model), the UE 115-a may (e.g., at 255) determine the second expiration time. In some cases, each status PDU (e.g., each status report) may be associated with a retransmission number (e.g., counting the quantity of retransmissions of a status PDU for one or more missing RLC PDUs), and the UE 115-a may determine the second expiration time for each retransmission number, for a set of retransmission numbers, or for all retransmission numbers (e.g., determining a fixed expiration time). For example, the UE 115-a may determine the second expiration time based on a retransmission number of the second status report 210 (e.g., based on a quantity of retransmissions of the first status report 205 that were transmitted prior to the second status report 210), latencies associated with receiving responses to previous status reports, respective triggering events, or a combination thereof. In some examples, the UE 115-a may determine a shorter second expiration time as the retransmission number of the second status report 210 increases (e.g., 20 ms expiration time for a first retransmission, 10 ms expiration time for a second retransmission, 5 ms for a third retransmission, and so on).

In some examples, the UE 115-a may determine the second expiration time by selecting a value from the range of values, a set of values, or both. For example, the UE 115-a may receive control signaling 220, which may indicate one or more parameters associated with RLC status PDU reporting. In some cases, the one or more parameters may include a range of values for the second expiration time (e.g., one or more threshold values, a maximum value and a minimum value), a set of possible values for the second expiration time, or both, and the UE 115-a may select a value from the range of values or the set of possible values based on the one or more predictions of the ML model.

In some examples, the UE 115-a may report (e.g., transmit an indication of) the determined second expiration time to the network entity 105-a (e.g., or the UE 115-b). In some cases, the UE 115-a may report the second expiration time for each retransmission number (e.g., a set of second expiration times corresponding to a set of retransmission numbers), for a group of retransmission numbers, or any combination thereof. Additionally, or alternatively, if the UE 115-a receives the range of values or the set of values, the UE 115-a may indicate an index of the set of values, or a value of the range of values, as the second expiration time. In some cases, the UE 115-a may indicate the second expiration value to the network entity 105-a via a MAC CE, an RLC Control PDU, an RRC message, or any combination thereof. Additionally, or alternatively, the UE 115-a may indicate the second expiration time to the network entity 105-a via a status report (e.g., such as the second status report 210). In some examples, each (e.g., every) status report transmitted by the UE 115-a (e.g., to the network entity 105-a) may include an indication of a determined second expiration time.

In some cases, the UE 115-a may indicate the second expiration time to the network entity 105-a as a recommendation. For example, the UE 115-a may receive a configuration of an expiration time to use (e.g., via the control signaling 220) as an initial expiration time for the timer (e.g., an expiration time with which the timer is started). In some cases, the configured expiration time may be based on (e.g., may be) the recommended expiration time. Alternatively, the configured expiration time may not be the recommended expiration time based on the network entity 105-a selecting a different expiration time for the initial expiration time.

Additionally, or alternatively, at 260, the UE 115-a may determine one or more event triggers that (e.g., after occurrence) trigger the generation of a status PDU and the transmission of a status report including the status PDU. In some cases, the event triggers may not be related to the timer (e.g., may not be associated with an expiration or value of the timer). That is, the event triggers may occur at any time before or after the initial expiration time or the second expiration time of the timer. In some examples, the UE 115-a may reset the timer (e.g., set the timer to zero, restart the timer) based on transmitting the second status report 210 in response to the occurrence of one or more of the event triggers.

In some cases, the UE 115-a may determine the event triggers based RLC or HARQ parameters at the UE 115-a, the predictions output by the ML model, or both. For example, the event triggers may be based on transport block size (e.g., status PDUs associated with messages carrying larger transport blocks may be retransmitted sooner), a component carrier associated with the RLC PDUs, a predicted payload of the RLC PDUs (e.g., status PDUs associated with low latency traffic may be retransmitted sooner), or any combination thereof. As one example, the event triggers may include a prediction of HARQ or RLC loss (e.g., HARQ NACK-to-ACK loss, a prediction that a HARQ message is lost). Additionally, or alternatively, if the UE 115-a is associated with a plurality of links with the network entity 105-a (e.g., or the UE 115-b, a dual connectivity scenario), the UE 115-a may set the event trigger to be a change in one of the links (e.g., in an RLC entity, a degradation past a threshold link quality). In the case that the UE 115-a transmits the second status report 210 to the network entity 105-a based on a change in the link quality, the UE 115-a may indicate to the network entity 105-a to use a different link (e.g., within the second status report 210 or via other signaling).

In some examples, the UE 115-a may receive control signaling 220, which may include a configuration for the UE 115-a associated with determining the second expiration time, the one or more event triggers, or both. The configuration may indicate one or more other parameters, such as one or more of the parameters of Table 1.

TABLE 1

| Parameter | Definition |
|---|---|
| min-t-StatusProhibit | A minimum value that the UE 115-a |
| | may determine for the expiration |
| | time. |
| max-t-StatusProhibit | A maximum value that the UE 115-a |
| | may determine for the expiration |
| | time. |
| min-t-StatusProhibit-retransmis- | Minimum and maximum expiration |
| sion(s), max-t-StatusProhibit-re- | time values for status PDU |
| transmission(s) | retransmissions. |
| AIML-allowed | An indication of whether ML |
| | behavior with respect to RLC status |
| | reporting is allowed. |
| QOSFlowsAllowed | An indication of whether ML |
| | behavior with respect to RLC status |
| | reporting for a specified QoS flow |
| | is allowed. |
| Allowed_event_triggered_Sta- | An indication of whether RLC status |
| tus_reporting | reporting based on UE-determined |
| | event triggers is allowed. |
| Mandatory_event_triggered_Sta- | A set of mandatory status reporting |
| tus_reporting | event triggers configured by the |
| | network entity 105-a. |
| Limit_On_duplicate_retrans- | A network performance threshold |
| missions | (e.g., maximum threshold) for a |
| | quantity of duplicate transmissions |
| | associated with status reporting (e.g., |
| | a KPI for the ML model). |
| Limit_on_status_reporting_rate | A threshold rate of RLC status |
| | reporting (e.g., a status reporting |
| | KPI). |

In some examples, min-t-StatusProhibit-retransmission(s) and max-t-StatusProhibit-retransmission(s) may indicate a minimum and maximum expiration time for all status PDU retransmissions, or may indicate respective minimum and maximum expiration times for each retransmission number of a status PDU. In some cases, if a parameter allows or disallows a feature, the UE 115-a may enable the feature (e.g., if allowed) or disable the feature (e.g., if disallowed or not allowed). In some examples, the Mandatory_event_triggered_Status_reporting may list event triggers that the network entity 105-a configures for the UE 115-a, which may include HARQ NACK-to-ACK errors (e.g., loss of a HARQ message, where a NACK HARQ message may be misinterpreted at the network entity 105-a to be an ACK). In some examples, the Limit_on_status_reporting_rate may be in the form of a threshold quantity of bytes per second (e.g., maximum quantity of bytes per second) associated with status reporting.

After determining the second expiration time, the one or more event triggers, or both, the UE 115-a may set the timer with the second expiration time, configure the one or more event triggers, or both. Once a value of the timer satisfies the second expiration time, one of the one or more event triggers occurs, or both (e.g., whichever happens first), the RLC entity of the UE 115-a may (e.g., at 265) generate (e.g., output, send) a second RLC status PDU (e.g., a copy of the first RLC status PDU in the first status report 205). Accordingly, the UE 115-a may transmit the second RLC status PDU to the network entity 105-a (e.g., or the UE 115-b) in the second status report 210. Thus, the UE 115-a may select a transmission time for the status PDU, which may reduce latency associated with RLC operations at the UE 115-a.

As shown in Table 1, the UE 115-a may be configured with (e.g., via the control signaling 220) one or more parameters associated with one or more KPIs for RLC status reporting (e.g., Limit_On_duplicate_retransmissions, Limit_on_status_reporting_rate). For example, the one or more KPIs may include a threshold latency (e.g., a threshold quantity of time) for a group of one or more RLC PDUs (e.g., per PDU set, per QoS flow, per any other packet categorization method). In some examples, the UE 115-a may receive one or more KPIs for the ML model as well, including a threshold quantity of excess RLC status reporting (e.g., when compared to transmitting status reports only after expiration of the timer). For example, the UE 115-a may determine the excess RLC status reporting based on counting duplicated PDUs received at the RLC entity or a PDCP layer of the UE 115-a (e.g., indicating that the UE 115-a transmitted a status PDU requesting a PDU retransmission when the PDU was already being retransmitted to the UE 115-a). Additionally, or alternatively, the network entity 105-a may observe RLC status reporting in the wireless communications system 200 and may determine if the RLS status reporting is excessive, too soon, or not useful based on one or more thresholds or parameters.

In cases where the UE 115-a does not maintain the one or more KPIs (e.g., does not satisfy the one or more KPIs), the UE 115-a may be configured with a fallback behavior. For example, if the UE 115-a is transmitting status reports above a threshold quantity or receiving duplicate PDUs at the RLC entity above a threshold quantity (e.g., as indicated by the one or more KPIs, based on dynamic status report timing selection), the UE 115-a may perform the fallback behavior. In some examples, the fallback behavior may include the UE 115-a returning to non-AIML (e.g., legacy) behavior for a period of time (e.g., a backoff time period). The fallback behavior may also include the UE 115-a transmitting a KPI violation report to the network entity 105-a (e.g., or a network AI/ML server). Additionally, or alternatively, the fallback behavior may include the UE disabling the ML behavior associated with RLC status reporting.

In some examples, the UE 115-a may transmit a capability message 215 to the network entity 105-a (e.g., or the UE 115-b). For example, the capability message 215 may indicate a capability of the UE 115-a to support predictive (e.g., ML model based) expiration time selection for the timer, a capability of the UE 115-a to support RLC status reporting based on the dynamic second expiration time, the UE-determined event triggers, or both, an ML model accuracy (e.g., based on duplicate transmissions associated with transmitting status reports before the initial expiration of the timer), one or more KPIs or KPI values (e.g., throughput or latency KPIs) that the UE 115-a supports as a function of channel quality indicator (CQI), or any combination thereof.

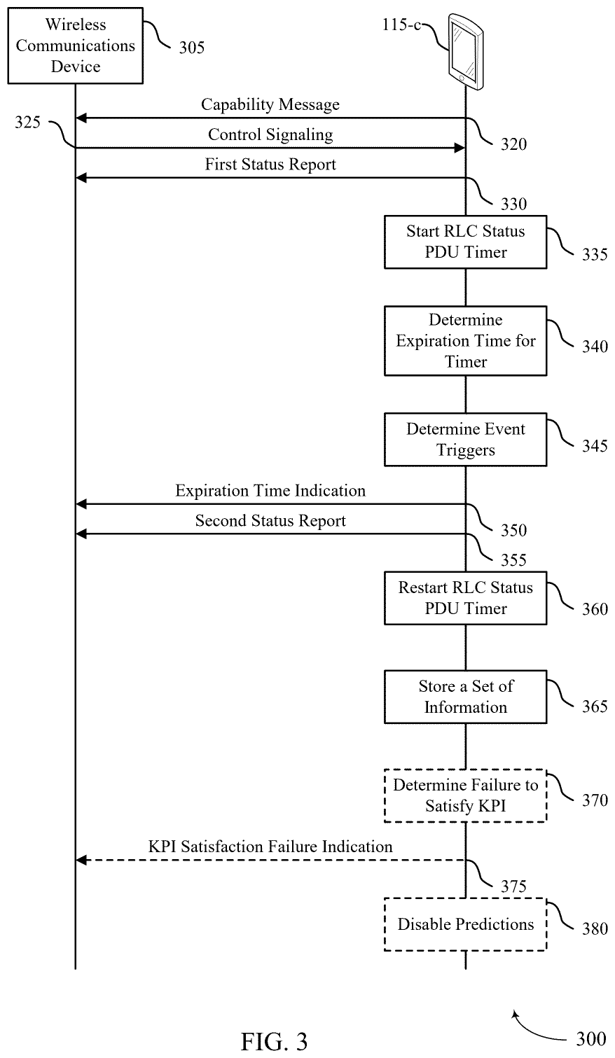

FIG. 3 shows an example of a process flow 300 that supports RLC status report timing selection in accordance with one or more aspects of the present disclosure. In some cases, aspects of the process flow 300 may implement or be implemented by aspects of FIGS. 1 and 2. For example, the process flow 300 may include a UE 115-c and a wireless communications device 305, where the UE115-c may be an example of a UE 115 as described herein with respect to FIGS. 1 and 2, and the wireless communications device 305 may be an example of a UE 115, a network entity 105, or another wireless communications device as described herein with respect to FIGS. 1 and 2. In some aspects, the UE 115-c may determine one or more of a second expiration time for a timer (e.g., an RLC status PDU retransmission timer) and one or more event triggers associated with RLC status PDU retransmission, and may transmit a status PDU (e.g., a second status PDU) based on one or more of the expiration time and the event triggers.

In the following description of process flow 300, the operations may be performed in a different order than the order shown, or other operations may be added or removed from the process flow 300. For example, some operations may also be left out of process flow 300, may be performed in different orders or at different times, or other operations may be added to process flow 300. Although the UE 115-c and the wireless communications device 305 are shown performing the operations of process flow 300, some aspects of some operations may also be performed by one or more other wireless devices or network devices. For example, the operations performed by the UE 115-c may also be performed by one or more other devices including a network entity 105.

At 320, the UE 115-c may transmit a capability message to the wireless communications device 305. In some cases, the capability message may indicate a capability of the UE 115-c to determine an expiration time for a timer (e.g., an RLC status PDU timer, the second expiration time), to determine one or more event triggers associated with the timer, or both, based on the output of (e.g., predictions from) an ML model. For example, the capability message may include an indication of an accuracy of the ML model for generating one or more outputs, an indication of one or more KPIs (e.g., supported KPIs) associated with the ML model, or any combination thereof (e.g., as described herein with respect to FIG. 2). For example, the one or more KPIs may indicate one or more throughput parameters supported by the UE 115-c, one or more latency parameters supported by the UE 115-c, one or more communication performance targets supported by the UE 115-c, or any combination thereof.

At 325, the UE 115-c may receive control signaling from the wireless communications device 305. For example, the control signaling may indicate a configuration of one or more parameters associated with sending a status PDU (e.g., the second status PDU, one or more status PDU retransmissions) in response to the timer satisfying an expiration time (e.g., the second expiration time), the occurrence of the one or more event triggers, or both. In some cases, the one or more parameters may include a minimum value of the timer (e.g., of the second expiration time), a maximum value of the timer (e.g., of the second expiration time), a range of values for the timer (e.g., second expiration time) corresponding to respective status PDUs of one or more status PDUs (e.g., status PDUs transmitted after and in addition to the status PDU of 330), an indication of whether the ML model is allowed (e.g., enabled) for the one or more predictions, an indication of whether the ML model is allowed (e.g., enabled) for one or more QoS flows, an indication of whether sending the one or more status PDUs in response to the one or more event triggers is enabled, an indication of respective event triggers of the one or more event triggers for sending the one or more additional status PDUs, one or more KPIs, a reporting threshold associated with the one or more status PDUs, or any combination thereof (e.g., as described herein with respect to Table 1).

At 330, the UE 115-c may send (e.g., to the wireless communications device 305) a first status PDU associated with an RLC entity of the UE 115-c. That is, the UE 115-c may transmit a first status report including a first RLC status PDU generated by the UE 115-c. For example, the RLC entity of the UE 115-c may detect a missing RLC PDU in the RLC protocol layer, may receive a message from the wireless communications device 305 triggering the output of the RLC status PDU, or both, and may output the RLC status PDU accordingly. The UE 115-c may process the RLC status PDU through one or more other protocol layers, and may transmit the status PDU (e.g., in a status report, in a status transmission) to the wireless communications device 305.

At 335, the UE 115-c may start (e.g., initiate, instantiate) a timer (e.g., t-StatusProhibit, and RLC status PDU retransmission timer) in response to sending the first status PDU. In some examples, the timer may prohibit sending one or more additional status PDUs (e.g., retransmissions of the first status PDU, including a second status PDU) associated with the RLC entity until after a first expiration time (e.g., an initial expiration time). In some examples, the UE 115-c may start the timer and assign the timer the first expiration time. In some cases, the first expiration time may be a standard expiration time (e.g., configured to the UE 115-c, such as described herein with respect to FIG. 2).

At 340, the UE 115-c may determine the second expiration time for the timer based on one or more predictions (e.g., from or based on the output of an ML model) for sending the one or more additional status PDUs. In some examples, determining the second expiration time may include selecting a value of the second expiration time from within a range of values configured to the UE 115-c. For example, the control signaling of 325 may include an indication of the range of values, and the UE 115-c may select a value from the range of values for the timer based on one or more predictions and the output of the ML model (e.g., as described herein with respect to FIG. 2). In some cases, the UE 115-c may determine the value of the second expiration time based on a quantity of retransmissions associated with one or more PDUs (e.g., previous retransmission, before transmission of the second status PDU at 355, a retransmission number of the second status PDU), a latency parameter, the occurrence of (e.g., previous occurrences of) one or more event triggers, or any combination thereof.

At 345, the UE 115-c may determine the one or more event triggers for transmitting the second status PDU before expiration of the timer. For example, the UE 115-c may determine the one or more event triggers based on one or more predictions (e.g., based on the ML model output) for sending the one or more additional status PDUs. For example, the one or more event triggers may be based on (e.g., may include) a predicted loss of a HARQ message from the wireless communications device 305. For example, the UE 115-c may expect the wireless communications device 305 to transmit a HARQ message in response to receiving the first status PDU, and the ML model may predict a loss of the HARQ message. In some examples, the prediction of the HARQ message being lost may be an event trigger.

In some examples, the UE 115-c may determine the one or more event triggers based on a transport block size associated with one or more messages, one or more component carriers used for transmitting the one or more messages, a predicted payload of the one or more messages, a latency parameter associated with the one or more messages, or any combination thereof. For example, the one or more messages may include one or more PDUs that were not received at the RLC entity of the UE 115-c (e.g., missing RLC PDU(s) that caused the UE 115-c to start the timer at 335), other signaling between the UE 115-c and the wireless communications device 305, or both. Additionally, or alternatively, the one or more event triggers may be associated with (e.g., may include) a change in performance of one or more communication links (e.g., a loss of an RLC link between the UE 115-c and the wireless communications device 305).

At 350, the UE 115-c may transmit an indication of the second expiration time to the wireless communications device 305 (e.g., in response to determining the second expiration time). In some cases, the indication of the second expiration time may include an indication of the selected value from within the range of configured values (e.g., from the control signaling of 325). Additionally, or alternatively, the indication of the second expiration time may include one or more recommended values corresponding to the second expiration time, where the one or more recommended values may be based on one or more outputs (e.g., predictions) of the ML model. For example, the wireless communications device 305 may receive the one or more recommended values and may configure the UE 115-c with a third expiration time (e.g., for subsequent RLC status PDU timers, an initial expiration time) based on (e.g., from) the one or more recommended values (e.g., using RRC signaling, an RLC-Config information element). In some examples, the UE 115-c may transmit a control message that includes the indication of the second expiration time, where the control message may include a MAC control element, an RLC control PDU, an RRC message, or any combination thereof.

At 355, the UE 115-c may send (e.g., transmit, output) a second status PDU associated with the RLC entity to the wireless communications device 305. For example, the UE 115-c may transmit a second status report that may include a second RLC status PDU (e.g., a copy or retransmission of the first status PDU). In some cases, the UE 115-c may send the second status PDU in response to the timer satisfying the second expiration time, an occurrence of the one or more event triggers, or both. In some cases, the UE 115-c may configure the second expiration time for the timer and one or more event triggers, and may transmit the second status PDU based on whichever occurs first. In some examples, the UE 115-c may send the second status PDU based on the ML model satisfying one or more KPIs (e.g., the KPIs received in the control signaling at 325, an accuracy KPI), where the one or more KPIs may be associated with a set of statistics indicating a latency for processing of a set of PDUs, a quantity of status PDUs that satisfy a threshold, or any combination thereof.

The second status PDU may include one or more indications. In some examples, a change in performance of one or more wireless communication links (e.g., an RLC link loss, poor connection via an RLC link between the UE 115-c and the wireless communications device 305) may be the event trigger that occurs and causes the UE 115-c to send the second status PDU. In such examples (e.g., or in other cases), the second status PDU may include an indication for the wireless communications device 305 to use a link (e.g., an RLC link) that is different than the one or more communication links based on the change in the performance. Additionally, or alternatively, the UE 115-c may transmit the second status PDU in accordance with one or more parameters of the configuration received at 325. Additionally, or alternatively, the second status PDU may include the indication of the second expiration time (e.g., as described at 350).

At 360, the UE 115-c may restart the timer (e.g., the RLC status PDU retransmission timer). For example, the UE 115-c may restart the timer based on sending the second status PDU in response to the occurrence of the one or more event triggers. Additionally, or alternatively, the timer may restart in response to reaching the second expiration time, or the UE 115-c may restart the timer based on sending the second status PDU when the timer reaches the second expiration time.

At 365, the UE 115-c may store a set of information (e.g., logs of data, as described herein with respect to FIG. 2) associated with sending the second status PDU (e.g., and one or more additional status PDUs, status PDUs previous to the first status PDU) in response to the timer satisfying the second expiration time (e.g., or a previous second expiration time), the occurrence of the one or more event triggers (e.g., or one or more previous event triggers), or both. In some examples, determining the second expiration time (e.g., as at 340), the one or more event triggers (e.g., as at 345), or both, based on the one or more predictions is in accordance with the set of information. For example, the ML model may use the set of information as inputs to generate the one or more predictions. In some cases, the set of information may include respective values of expiration times for the timer over a first duration (e.g., determined expiration times at which the UE 115-c transmitted status PDU retransmissions), respective event triggers of the one or more event triggers over a second duration (e.g., determined event triggers at which the UE 115-c transmitted status PDU retransmissions within a window of time), one or more sequence numbers of one or more RLC PDUs corresponding to a quantity of retransmissions, one or more sequence numbers of one or more RLC PDUs corresponding to a latency, information associated with a quantity of duplicate RLC PDUs, information associated with a quantity of duplicate PDCP PDUs, or any combination thereof.

In some examples, the UE 115-c may transmit a report indicating at least a portion of the set of information that is collected by the UE 115-c. For example, the report may be sent to the wireless communications device 305, to a network entity 105, to an AI/ML server, another device or entity, or any combination thereof. In some examples, the UE 115-c may transmit the report based on storing the set of information associated with sending the one or more additional status protocol data units. The UE 115-c may transmit the report periodically, aperiodically, or based on receiving a request for the report.

At 370, the UE 115-c may determine that sending the second status PDU (e.g., at 355) fails to satisfy (e.g., causes the UE 115-a or the ML model to fail to satisfy) one or more KPIs (e.g., as described herein with respect to FIG. 2). In some examples, one or more status PDUs that the UE 115-c sends after the second status PDU may be sent in accordance with the first expiration time (e.g., default expiration time) of the timer based on failing to satisfy the one or more KPIs.

At 375, the UE 115-c may transmit, to the wireless communications device 305, a message indicating that sending the second status PDU failed to satisfy the one or more KPIs. In some examples, the UE 115-c may transmit the message based on determining that sending the second status PDU failed to satisfy the one or more KPIs.

At 380, the UE 115-c may disable the one or more predictions for determining the second expiration time for the timer, the one or more event triggers, or both. For example, the UE 115-c may set a parameters to reduce or disable the ability of the ML model to generate the one or more predictions. In some cases, the UE 115-c may disable the one or more predictions based on determining that sending the second status PDU failed to satisfy the one or more KPIs. In some examples, the operations at 375 and 380 may assist the UE 115-c in returning to satisfy the one or more KPIs.

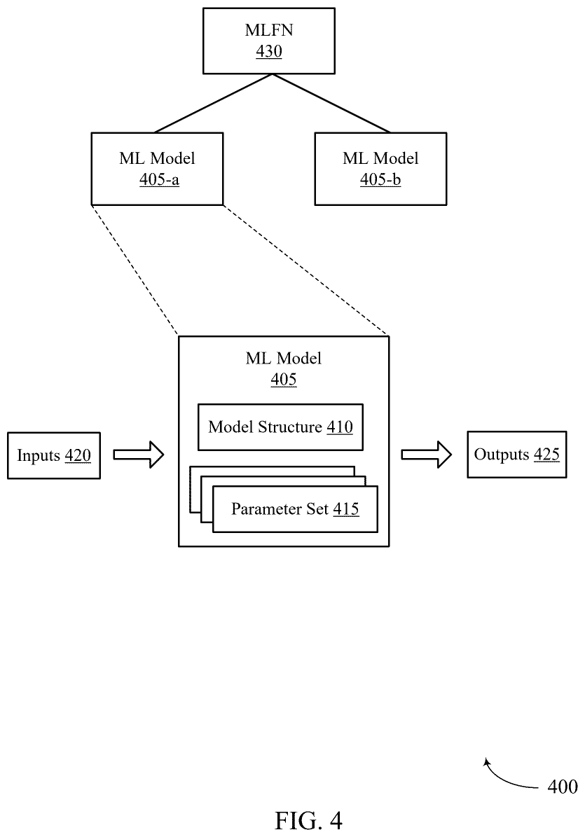

Thus, according to the techniques described herein, the UE 115-c may send a second status PDU at a time different from (e.g., earlier than) an initial expiration time of the timer. Such techniques may reduce a latency of the UE 115-c associated with receiving and processing information at the RLC layer of the UE 115-c. Additionally, or alternatively, such techniques may include AI or ML functions, as further described herein with respect to FIGS. 4-14.

FIG. 4 shows an example of an ML architecture 400 that supports RLC status report timing selection in accordance with one or more aspects of the present disclosure. The ML architecture 400 illustrates an implementation for ML models 405 (e.g., artificial intelligence models), which may be used to perform one or more of the features described herein.

In some cases, the techniques described herein may utilize an ML model 405, which may generate a set of one or more outputs 425 (e.g., predictions as described herein with respect to FIGS. 1-3) based on a set of one or more inputs 420 (e.g., the received data, as described herein with respect to FIGS. 2-3). For example, the ML model 405 may be a data driven model (e.g., algorithm), which uses ML techniques (e.g., AI techniques) to generate the outputs 425. In some cases, the ML model 405 may be described using a model structure 410. For example, the ML model 405 may include one or more computation graphs, and the model structure 410 may define a structure for the ML model 405 for generating the outputs 425. In some examples, the ML model 405 may include one or more parameter sets 415. The parameter sets 415 may be neural network weights, for example, which may be used in combination with the model structure 410 to generate the outputs 425. In some examples, the ML model 405 (e.g., alone or in combination with other ML models 405) may implement an ML function (e.g., an AI function) which may generate the outputs 425 based on the inputs 420.

In some examples, an ML feature name (MLFN) 430 may be used to identify a function performed by one or more ML models 405. For example, the MLFN 430 may correspond to CSI feedback, beam, positioning, or other functionalities. In some cases, the one or more ML models 405 may be identified using a model ID. For example, the MLFN 430 may be associated with one or more model IDs corresponding to one or more ML models 405 (e.g., an ML model 405-a and an ML model 405-b). Each model ID may correspond to (e.g., and identify) an ML model 405 having a defined model structure 410, one or more parameter sets 415, or a combination thereof, as described herein. Additionally, or alternatively, an MLFN 430 may identify one or more ML models 405 using model structure IDs (e.g., MS IDs), parameter set IDs (E.g., PS IDs), or both. For example, the MLFN 430 may be associated with one or more model structure IDs, and each structure ID may identify a model structure 410 of an ML model 405. The MLFN 430 (e.g., or each structure ID) may also be associated with one or more parameter set IDs, each parameter set ID identifying a corresponding parameter set 415 for use with the corresponding model structure 410.

As such, model information may include MLFNs 430, model IDs, a model structure IDs, parameter set IDs, or a combination thereof. In some examples, each model ID may be associated with a model structure and one or more parameter sets, and may be represented by a string. For instance, the string may correspond to a flat namespace, such as a single value that represents a tuple that includes the model structure and the one or more parameter sets. Alternatively, the string may be a hierarchical namespace, such as the tuple including the model structure and the one or more parameter sets.

In some cases, each model ID may be unique with respect to an MLFN 430. For example, each model ID may identify a separate ML model 405 (e.g., for a vendor), and may be unique such that each model ID refers to a single corresponding ML model 405. Similarly, each model structure ID may also be unique with respect to an MLFN 430. In some cases, each model ID, model structure ID, or both, may be specific to a public land mobile network (PLMN). Additionally, or alternatively, the model IDs and model structure IDs may be standardized or may administered separately (e.g., per vendor) without standardizing.

A network entity 105 (e.g., a network) may configure and manage the use of ML models 405 for a UE 115. In some examples, the network entity 105 may manage ML at the UE 115 at a feature level, for example, by configuring the UE 115 by indicating an MLFN 430. Additionally, or alternatively, the network entity 105 may manage ML models 405 within each feature, and may configure the UE 115 using specific model IDs (e.g., indicating a model structure 410 and one or more parameter sets 415) corresponding to each feature. In some examples, the network entity 105 may manage the parameters of each ML model, and the network entity 105 may configure the UE 115 by indicating a model structure ID corresponding to a model structure 410 and one or more parameter sets 415. The parameter sets 415 may be explicitly indicated by the network entity 105 to the UE 115, which may allow for more flexibility of the parameters, and may reduce the storage requirements at the UE 115 for storing predetermined parameter sets 415. Alternatively, the network entity 105 may indicate the parameter sets 415 using one or more parameter IDs, which may reduce communication overhead between the UE 115 and the network entity 105.

In some examples, ML models 405 may be one-sided models, which may be performed entirely at a UE 115 or the network (e.g., at one or more network entities 105), or two-sided models, which may be performed at both the UE 115 and the network. One-sided models may be UE-side ML models 405, in which inference (e.g., running of the ML models 405) is performed at the UE 115. For example, the UE-side ML models 405 may involve non-UE specific inputs 420 (e.g., common to multiple UEs 115) and UE-specific inputs 420 (e.g., control inputs 420). In some cases, the UE 115 may receive control signaling or additional inputs 420 for the ML models 405 from a network entity 105, while the ML model 405 inference is performed entirely at the UE 115. Inference for network-side ML models 405 may be performed at the network (e.g., at one or more network entities 105), and the network may receive inputs 420 from the UE 115 to enter into the ML models 405. In some examples, the network may indicate the outputs 425 to the UE 115.

In two-sided ML models 405, joint inference may be performed. For example, one part of inference may be performed by the UE 115, and a remaining portion of the inference may be performed by one or more network entities 105. For example, the UE 115 may perform a first portion of the inference for an ML model 405, and the network may perform a second part of the inference (e.g., based on data received from the UE 115, for example). Alternatively, the network may perform the first portion of the inference for an ML model 405, and the UE 115 may perform the second part of the inference (e.g., based on data received from the network entity 105, for example). To perform inference for the two-sided ML model 405, a network entity 105 may signal one or more inputs 420 or other control signaling to the UE 115. Additionally, or alternatively, the UE 115 may transmit signaling indicating one or more inputs 420 or other control signaling to the network.

Accordingly, the ML models 405 may be performed at a UE 115 or at one or more network entities 105, as managed by the network, to perform different functions that may improve the operations and efficiency of the UE 115 and the network as described herein. For example, the ML models 405 may be used to support RLC status report timing selection in accordance with the described techniques, which may include techniques for determining a dynamic expiration value for a timer, determining one or more event triggers for retransmitting a status PDU, or both, based on the output of the ML model 405. For example, the UE may start the timer in response to outputting a first status PDU from an RLC entity of the UE, where the timer may have a first expiration time. The UE may determine the second expiration time, the one or more event triggers, or both, based on one or more predictions associated with RLC status reporting generated by the ML model 405. An RLC entity of the UE may send a second status PDU based on the timer satisfying the second expiration time, based on an occurrence of the one or more event triggers, or both.

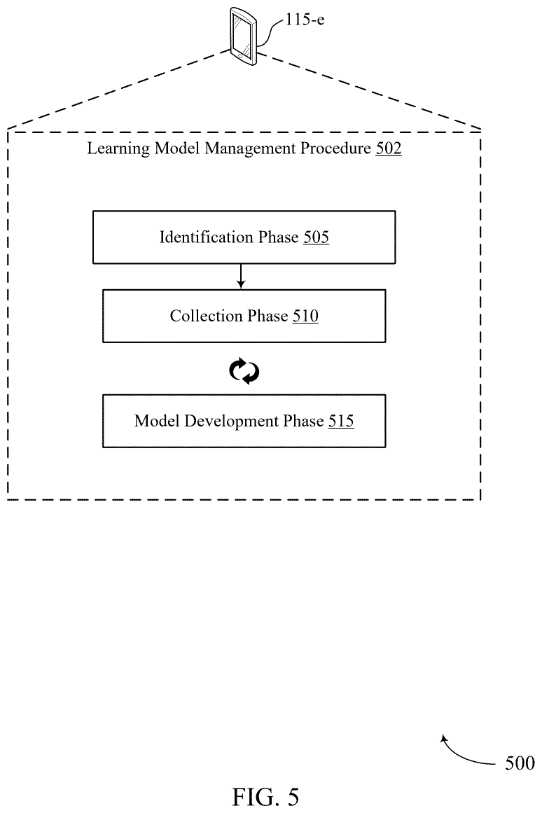

FIG. 5 shows an example of a block diagram 500 of a UE 115-d that supports RLC status report timing selection in accordance with one or more aspects of the present disclosure. The UE 115-d may be an example of aspects of a UE 115 as described herein with reference to FIGS. 1-3, respectively. The UE 115-d may implement aspects of the wireless communications system 100 and the wireless communications system 200, as described with reference to FIGS. 1 and 2, respectively.

In the example of FIG. 5, the UE 115-d may support a learning model management procedure 502 associated with one or more ML models for RLC status report timing selection, as described herein. In some cases, the term “learning model,” as used herein, may be used interchangeably with “ML model.” The learning model management procedure 502 may include one or more of an identification phase 505, a collection phase 510 (also referred to as a data collection phase), and a model development phase 515.

One or more operations of the learning model management procedure 502 may be implemented by the UE 115-d or components (e.g., one or more memories storing processor-executable code, one or more processors coupled with the one or more memories and individually or collectively operable to execute the code to cause the UE 115-d to perform the operations) as described herein. In the following description of the learning model management procedure 502, the one or more operations performed by the UE 115-d may be performed in different orders or at different times. Some operations may also be omitted from the learning model management procedure 502, and other operations may be added to the learning model management procedure 502.

During the identification phase 505, the UE 115-d may identify an opportunity of applying a learning model. For example, the UE 115-d may identify a machine learning feature (MLF) for development at the UE 115-d. The UE 115-d may determine a use case for the learning model. In some examples, the UE 115-d may determine a task (e.g., an action) associated with the learning model, may determine inputs and outputs of the learning model, or both.

During the collection phase 510, the UE 115-d may collect data. For example, the UE 115-d may collect data based on actions or measurements that the UE 115-d performs, or the UE 115-d may collect data from multiple network elements (e.g., UEs, network entities). The data collected may be used as an input to the learning model for model development.

During the model development phase 515, the UE 115-d may prepare the data (e.g., before inputting the data to the learning model, as part of inputting the data to the learning model). To prepare the data, the UE 115-d may utilize one or more data filters, one or more selection criteria, or other data preparation parameters or procedures. The UE 115-d may design the model. A design of the learning model may be based on the MLF, the data available to the UE 115-d, one or more target outputs of the learning model, or a combination thereof. The UE 115-d may train the learning model (e.g., using the input data), and the UE 115-d may perform validation and testing of the learning model. For example, the UE 115-d may determine an accuracy or a reliability of the learning model and may calculate one or more accuracy metrics of the learning model. In some examples, the UE 115-d may continue to collect data for the learning model until the learning model has reached a threshold accuracy or reliability.

In some examples, multiple models may be developed for a same MLF (e.g., a same use case). The different models may be applicable to difference deployment environments, scenarios, or regions (e.g., geographical regions). In some examples, learning models may be universal models and may be generalized models that are applicable across deployments (e.g., all deployments). Universal models may be device specific or hardware specific. Some learning models may be regional models which may be deployment specific or network specific. Regional models may be applicable to some deployments, networks, and/or regions, but not others. Some learning models may be local models which may be applicable to a specific cell or to a local geographical area.

In some examples, the UE 115-d may be capable of out-of-band or on-demand download of learning models. For example, because some models may be regional models or local models, the UE 115-d may download such learning models once the UE 115-d is in the field (e.g., on-demand downloading). In some examples, on-demand downloading of learning models at the UE 115-d may enable the UE 115-d to perform firmware over-the-air (FOTA) updates of existing models (e.g., downloaded models, such as out-of-band downloaded models), which may support federated learning of learning models.

Additionally, or alternatively, the learning model management procedure 502 may include a deployment of one or more learning models. For example, a UE 115-d may perform delivery or reception of a learning model (e.g., via an over the air interface or other signaling). That is, the UE 115-d may transmit an indication of the learning model to a network entity 105 or may receive an indication of the learning model from a network entity 105. In some examples, the indication of the learning model may indicate a partial model or a full model. A structure of the learning model may be known at a device receiving the learning model and the indication may include parameters for the model, or the indication may include a model (e.g., a model structure unknow by the receiving device) and parameters for the model.

In some examples, the indication of the learning model may include a model executable. The model executable may be optimized for different hardware platforms based on capabilities of the hardware platform and/or performance tradeoffs. The model executable may be downloaded directly to the UE 115-d or may be retrieved by the UE 115-d from a model repository. In some cases, due to a memory restriction at the UE 115-d, the UE 115-d may download the learning model at runtime.

In some examples, the indication of the learning model may include one or more model management protocols. The model management protocols may include network and/or UE protocol functions to run the model. Additionally, or alternatively, the model management protocols may include L1/L2 or RRC function handling (e.g., CSI type III support, MAC-control elements (MAC-CEs), RRC signaling for channel state feedback (CSF) configuration. In some cases, the model management protocols may include updated UE capabilities handling information (e.g., UE radio capability for CSF and supported CSF models).

In some examples, the UE 115-d may retrieve the learning model from one or more model repositories. The model repository may store the model to download (e.g., transfer) to the UE 115-d. In some examples, the model repository may be a server (e.g., mobile network operator (MNO)). A model and parameter set configuration (e.g., indicating a set of learning models to be downloaded to the UE 115-d) may be configurable (e.g., dynamic), or may be static. Downloading the learning model to the UE 115-d may be in accordance with a model download format. The model download format may be a binary executable file or image or may be a model descriptor or label (e.g., in accordance with an open neural network exchange (ONNX)). In some examples, model quantization and/or compilation may be during an out-of-band period or may be during a runtime period of the UE 115-d.

A learning model may undergo a life cycle, where the learning model progresses from one step of the life cycle to another. Steps of the model life cycle may include model development, model deployment, and model execution. For example, after development of a learning model, the learning model may be deployed. Based on a model deployment, the UE 115-d may collect feedback of the ML model and may perform additional model development of the learning model (e.g., to improve or iterate on the learning model) based on the feedback. After model deployment, the ML model may be configured (e.g., for a particular use case, scenario), and the ML model may be executed by the UE 115-d. Based on model execution, the UE 115-d may collect feedback, may collect additional data, or both. The UE 115-d may perform model development of the ML model to improve the ML model based on the feedback and the additional data collected.

As described herein, the UE 115-d may support RLC status report timing selection. For example, the UE 115-d may determine a dynamic expiration value for a timer, determine one or more event triggers for retransmitting a status PDU, or both, based on the output of an ML model. For example, the UE 115-d may start the timer in response to outputting a first status PDU from an RLC entity of the UE 115-d, where the timer may have a first expiration time. The UE 115-d may determine the second expiration time, the one or more event triggers, or both, based on one or more predictions associated with RLC status reporting generated by the ML model. An RLC entity of the UE 115-d may send a second status PDU based on the timer satisfying the second expiration time, based on an occurrence of the one or more event triggers, or both

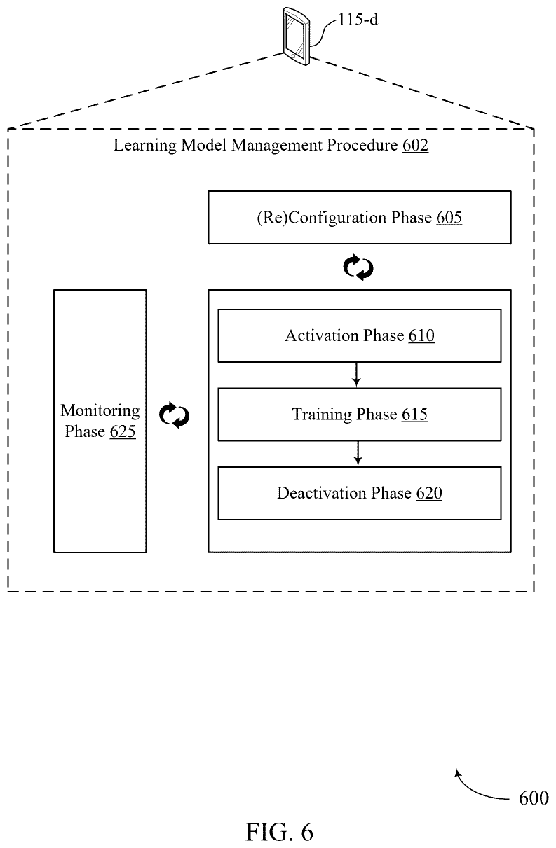

FIG. 6 shows a block diagram 600 of a UE 115-e that supports RLC status report timing selection in accordance with one or more aspects of the present disclosure. The UE 115-e may be an example of aspects of a UE 115 as described herein with reference to FIGS. 1-3. The UE 115-e may implement aspects of the wireless communications system 100 and the wireless communications system 200, as described with reference to FIGS. 1 and 2, respectively.

In some examples, a UE 115-e may support a learning model management procedure 602 associated with one or more ML models for RLC status report timing selection, as described herein. The learning model management procedure 602 may include one or more of a (re) configuration phase 605, an activation phase 610, a training phase 615 (also referred to as an inference phase), a deactivation phase 620, or a monitoring phase 625. The one or more learning models may be locally stored (e.g., one or more memories storing processor-executable code) at the UE 115-e. Alternatively, the UE 115-e may obtain (e.g., download) the one or more learning models, for example, via a network entity 105 or a base station, as described herein with reference to FIGS. 1 and 2.

One or more operations of the learning model management procedure 602 may be implemented by the UE 115-e or components (e.g., one or more memories storing processor-executable code, one or more processors coupled with the one or more memories and individually or collectively operable to execute the code to cause the UE 115-e to perform the operations) as described herein. In the following description of the learning model management procedure 602, the one or more operations performed by the UE 115-e may be performed in different orders or at different times. Some operations may also be omitted from the learning model management procedure 602, and other operations may be added to the learning model management procedure 602.

During the (re) configuration phase 605, the UE 115-e may receive, from a network entity 105 or a base station, a set of one or more configurations including a set of one or more parameters for configuring or reconfiguring one or more learning models (e.g., artificial intelligence models, ML models). The UE 115-e may receive, from a network entity 105 or a base station, a request message for configuring or reconfiguring the one or more learning models. The request may include the set of one or more configurations and one or more identifiers associated with one or more learning models. The UE 115-e may transmit, to the network entity 105 or the base station, a response message that includes an acknowledgment of the request message.

In some examples, the set of one or more parameters may be for managing (e.g., training, updating, modifying) the one or more learning models. In some other examples, the set of one or more parameters may be an input for the one or more learning models, for example, for inference of the one or more learning models. In other examples, the set of one or more parameters may be for monitoring one or more performance metrics (also referred to as KPIs) for the one or more learning models. Additionally, or alternatively, the set of one or more configurations may include one or more RRC configurations (e.g., one or more measurement configurations, one or more MAC configurations, or the like).

During the activation phase 610, the UE 115-e may activate at least one learning model (e.g., for at least one action). During the training phase 615, the UE 115-e may train the at least one learning model to obtain a set of one or more outputs based at least in part on a set of one or more inputs (e.g., a set of one or more parameters). During the deactivation phase 620, the UE 115-e may deactivate the at least one learning model (e.g., for at least one action).

During the monitoring phase 625, the UE 115-c may monitor (e.g., track) a performance of the at least one learning model. One or more of a network entity 105, a base station, or the UE 115-e may share (e.g., transmit, receive, exchange) feedback associated with the performance of the at least one learning model. The performance may be associated with a system performance (e.g., spectral efficiency, power consumption, delay, or the like) or a model performance (e.g., prediction accuracy, resource usage, inference delay, or the like). In some examples, one or more of a network entity 105, a base station, or the UE 115-e may trigger a switching event that includes switching (e.g., changing) from at least one learning model to at least one different learning model, for example, based at least in part on feedback associated with a performance of the at least one learning model. In some other examples, one or more of a network entity 105, a base station, or the UE 115-e may update the training of the at least one learning model based at least in part on the feedback associated with the performance of the at least one learning model.

The UE 115-e may switch from at least one learning model to at least one different learning model based at least in part on a function supported by the different learning model. In some examples, the UE 115-e may receive, from a network entity 105 or a base station, a request message to switch to the at least one different learning model. The request message may indicate an identifier associated with the at least one different learning model, and the UE 115-e may identify the least one different learning model based at least in part on the identifier. During the activation phase 610 of the learning model management procedure 602, the UE 115-e may activate the at least one different learning model (e.g., a different artificial intelligence/ML model). Additionally, during the deactivation phase 620, the UE 115-e may deactivate the at least one learning model (e.g., a current artificial intelligence/ML model).

Additionally, or alternatively, during the monitoring phase 625, the UE 115-e may trigger the switching event based at least in part on a change in one or more parameters of the UE 115-c (e.g., a quantity of antennas, a quantity of carriers, etc.). In some examples, the UE 115-e may trigger the switching event based at least in part on a change in a location of the UE 115-e (e.g., a change from an indoor environment to an outdoor environment, or vice-versa). In some other examples, the UE 115-e may trigger the switching event based at least in part on a change in a service (e.g., network slice, QoS flow, session, etc.).

Accordingly, the UE 115-c may be configured to support managing (e.g., configuring, reconfiguring, activating, deactivating, monitoring, reporting, or the like) of one or more machine leaning models. For example, as described herein, the UE 115-c may support RLC status report timing selection. In such cases, the UE 115-e may use an ML model, which may be implemented using the learning model management procedure 602, for determining a dynamic expiration value for a timer, determining one or more event triggers for retransmitting a status PDU, or both. For example, the UE 115-e may start the timer in response to outputting a first status PDU from an RLC entity of the UE, where the timer may have a first expiration time. The UE may determine the second expiration time, the one or more event triggers, or both, based on one or more predictions associated with RLC status reporting generated by the ML model. For example, the predictions from the ML model may include one or more probabilities that a missing RLC PDU will be received (e.g., that an RLC hole will be filled) at the UE 115-e after one or more corresponding potential expiration times of the timer, an expected latency of an RLC SDU (e.g., indicated by SN) and whether the RLC SDU will arrive at the RLC entity of the UE 115-e after the first expiration time of the timer or after another PDB-related threshold, a probability that the latency of the RLC SDU is within a threshold latency range (e.g., less than a maximum threshold latency, greater than a minimum threshold latency, both), a prediction of a latency distribution among RLC PDUs based on all RLC parameters and events, general predictions about RLC PDU arrival time or timer expiration, or any combination thereof. An RLC entity of the UE may send a second status PDU based on the timer satisfying the second expiration time, based on an occurrence of the one or more event triggers, or both.

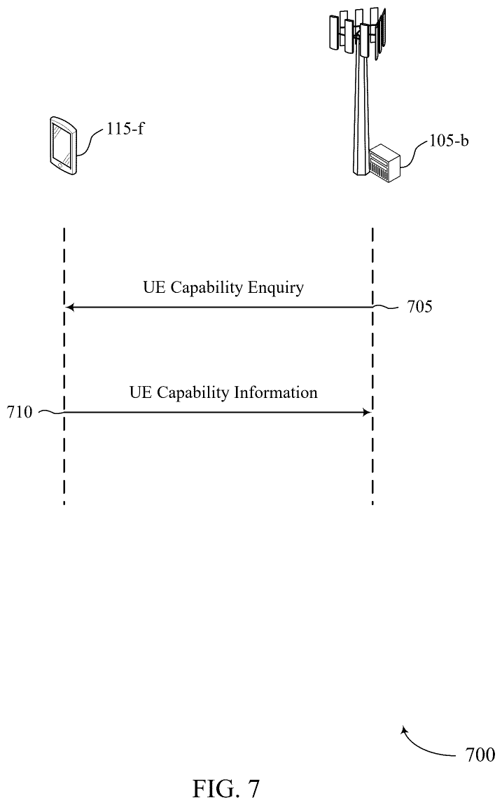

FIG. 7 shows an example of a process flow 700 that supports RLC status report timing selection in accordance with one or more aspects of the present disclosure. The process flow 700 may implement aspects of the wireless communications system 100 and the wireless communications system 200, as described with reference to FIGS. 1 and 2, respectively. The process flow 700 may include a UE 115-f and a network entity 105-b, which may be examples of UEs 115 and network entities 105 as described herein. In the following description of the process flow 700, the operations between the UE 115-f and the network entity 105-b may be transmitted in a different order than the example order shown, or the operations performed by the UE 115-f and the network entity 105-b may be performed in different orders or at different times. Some operations may also be omitted from the process flow 700, and other operations may be added to the process flow 700.

In some examples, the UE 115-f may support providing an indication to the network entity 105-b of one or more ML models, including one or more features for RLC status report timing selection, supported by the UE 115-f. At 705, the network entity 105-b may transmit, and the UE 115-f may receive, a request message (e.g., a UE capability enquiry). The UE 115-f may determine, in response to the UE capability enquiry, a set of one or more UE capabilities. For example, the UE 115-f may determine whether the UE 115-f supports AI/ML models and or functionalities, including one or more ML models (e.g., AI/ML models) or one or more features associated with the one or more learning models.

At 710, the UE 115-f may transmit, and the network entity 105-b may receive, a response messages (e.g., UE capability information), in response to the request message. The UE capability information may include a set of one or more features supported by the UE 115-f. In some examples, the UE capability information may include a set of one or more identifiers associated with the one or more learning models, supported by the UE 115-f. Additionally, or alternatively, the UE capability information may include at least one field (e.g., an IE, a flag, or the like) that indicates whether a corresponding learning model is loaded (e.g., initialized, stored, cached, or the like) at the UE 115-f. Additionally, or alternatively, the UE capability information may include a set of one or more identifiers associated with one or more learning model structures, or a set of one or more parameters for one or more features associated with the one or more learning model structures.

Accordingly, the UE 115-f may be configured to support exchange of UE capability information associated with one or more learning models. Further, the UE 115-f may support RLC status report timing selection. In such cases, the UE 115-f may use an ML model, which may be based on the UE capability information exchanged with the network entity 105-b, for predicting one or more probabilities that a missing RLC PDU will be received (e.g., that an RLC hole will be filled) at the UE 115-f after one or more corresponding potential expiration times of the timer, an expected latency of an RLC SDU (e.g., indicated by SN) and whether the RLC SDU will arrive at the RLC entity of the UE 115-f after the first expiration time of the timer or after another PDB-related threshold, a probability that the latency of the RLC SDU is within a threshold latency range (e.g., less than a maximum threshold latency, greater than a minimum threshold latency, both), a prediction of a latency distribution among RLC PDUs based on all RLC parameters and events, general predictions about RLC PDU arrival time or timer expiration, or any combination thereof. In some examples, the UE 115-f may determine an expiration time for an RLC status PDU retransmission timer, determine one or more trigger events for retransmitting a status PDU, or both, based on such predictions.

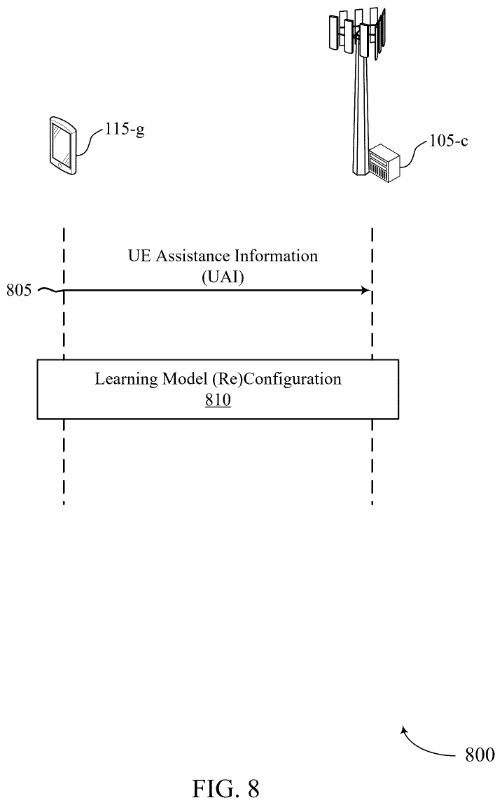

FIG. 8 shows an example of a process flow 800 that supports RLC status report timing selection in accordance with one or more aspects of the present disclosure. The process flow 800 may implement aspects of the wireless communications system 100 and the wireless communications system 200, as described with reference to FIGS. 1 and 2, respectively. The process flow 800 may include a UE 115-g and a network entity 105-c, which may be examples of UEs 115 and network entities 105 as described herein. In the following description of the process flow 800, the operations between the UE 115-g and the network entity 105-c may be transmitted in a different order than the example order shown, or the operations performed by the UE 115-g and the network entity 105-c may be performed in different orders or at different times. Some operations may also be omitted from the process flow 800, and other operations may be added to the process flow 800.

In some examples, the UE 115-g may support providing UE assistance information (UAI) to the network entity 105-c. More specifically, the UE 115-g may support transmitting, to the network entity 105-c, UAI for managing one or more learning models. At 805, the UE 115-g may transmit, and the network entity 105-c may receive, UAI that may indicate one or more restrictions (also referred to as restricted UE capabilities) associated with the one or more learning models. For example, the restricted UE capabilities may include a set of one or more learning models, a set of one or more identifier associated with the set of one or more learning models, or both. In some examples, the restricted UE capabilities may exclude the set of one or more identifiers. In some examples, the UE 115-g may indicate a request to adjust (e.g., reduce, decrease, increase) a concurrency of the one or more learning models. For example, the UE 115-g may indicate a threshold quantity of concurrency (e.g., “maxartificial intelligencemachine learningconcurrency-Preference”) associated with the one or more ML models.

The UE 115-g may generate and transmit the UAI to the network entity 105-c based at least in part on a condition (e.g., an event). One or more examples of a condition may include, but is not limited to, a battery level of the UE 115-g satisfying a battery level threshold, a processor usage level of one or more processors of the UE 115-g satisfying a processor usage level threshold, or a heat level of one or more processors of the UE 115-g satisfying a heat level threshold. For example, the UE 115-g may transmit the UAI to the network entity 105-b to manage (e.g., deactivate, activate) one or more learning models at the UE 115-g based at least in part on one or more of the battery level of the UE 115-g satisfying the battery level threshold, the processor usage level of the one or more processors of the UE 115-g satisfying the processor usage level threshold, or the heat level of the one or more processors of the UE 115-g satisfying the heat level threshold.

Additionally, or alternatively, in some examples, the UAI may include a request for a set of one or more configurations associated with one or more learning models. In some examples, the UE 115-g may request the network entity 105-b for the set of one or more configurations associated with the one or more learning models based at least in part on a change in an environment of the UE 115-g. In some other examples, the UE 115-g may request the network entity 105-c for the set of one or more configurations associated with the one or more learning models based at least in part on a change in a state of the UE 115-g (e.g., a change between one or more of an idle state, an inactive state, or a connected state).

In other examples, the UE 115-g may request the network entity 105-c for the set of one or more configurations associated with the one or more learning models based at least in part on a session establishment associated with a network slice. For example, the UE 115-g may establish a session (e.g., a PDU session) associated with the network slice, and request the network entity 105-c for the set of one or more configurations associated with the one or more learning models. In some other examples, the UE 115-g may request the network entity 105-c for the set of one or more configurations associated with the one or more learning models based at least in part on a change in a geographic coverage area of the UE 115-g. For example, the UE 115-g may enter a new geographic coverage area of a cell, PLMN, and request the network entity 105-c for the set of one or more configurations associated with the one or more learning models.

At least one configuration of the set of one or more configurations associated with provisioning of network data as input for one or more learning models (e.g., AI/ML models). In some examples, the at least one configuration may indicate at least one identifier associated with at least one learning model supporting the network data as input to the least one learning model. In some examples, the UE 115-g may request (e.g., on-demand) for the network data from the network entity 105-c via the UAI, for example, based at least in part on the set of one or more configurations associated with provisioning of network data as input for one or more learning models (e.g., AI/ML models).

At 810, one or more of the UE 115-g or the network entity 105-c may configure or reconfigure at least one learning model. For example, the network entity 105-c may select at least one learning model to deactivate at the UE 115-g, based at least in part on the UAI, and transmit control signaling (e.g., RRC, MAC-CE, DCI) for deactivating the at least one learning model. For example, the network entity 105-c may determine and select which learning model to deactivate at the UE 115-g based at least in part on the UAI, and transmit the control signaling (e.g., RRC, MAC-CE, DCI) that indicates for the UE 115-g to deactivate the at least one learning model. Additionally, or alternatively, the network entity 105-c may determine and select which learning model to configure or reconfigure and activate at the UE 115-g based at least in part on the UAI. For example, the network entity 105-c may determine and select which learning model to activate at the UE 115-g based at least in part on the UAI, and transmit control signaling (e.g., RRC, MAC-CE, DCI) that indicates for the UE 115-g to activate the at least one learning model.

Accordingly, the UE 115-g may be configured to support exchange of UAI for managing ML models that support RLC status report timing selection at the UE 115-g. For example, the UE 115-g may support RLC status report timing selection. In such cases, the UE 115-g may use an ML model, which may be configured (or re-configured) based on the UAI provided to the network entity 105-c, for predicting one or more probabilities that a missing RLC PDU will be received (e.g., that an RLC hole will be filled) at the UE 115-g after one or more corresponding potential expiration times of the timer, an expected latency of an RLC SDU (e.g., indicated by SN) and whether the RLC SDU will arrive at the RLC entity of the UE 115-g after the first expiration time of the timer or after another PDB-related threshold, a probability that the latency of the RLC SDU is within a threshold latency range (e.g., less than a maximum threshold latency, greater than a minimum threshold latency, both), a prediction of a latency distribution among RLC PDUs based on all RLC parameters and events, general predictions about RLC PDU arrival time or timer expiration, or any combination thereof. The UE 115-g may determine an expiration time of the timer, one or more event triggers, or both, based on such ML model predictions.

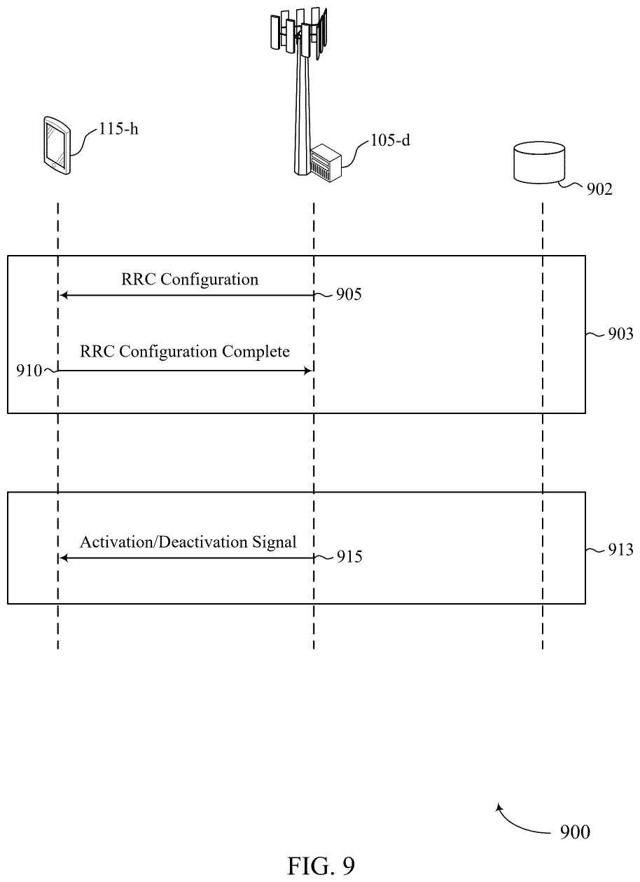

FIG. 9 shows an example of a process flow 900 that supports RLC status report timing selection in accordance with one or more aspects of the present disclosure. The process flow 900 may implement aspects of the wireless communications system 100 and the wireless communications system 200, as described with reference to FIGS. 1 and 2, respectively. The process flow 900 may include a UE 115-h and a network entity 105-d, which may be examples of UEs 115 and network entities 105 as described herein. Additionally, the process flow 900 may include a repository 902 (e.g., a database) storing one or more ML models, or information regarding the same. In the following description of the process flow 900, the operations between the UE 115-h, the network entity 105-d, and/or the repository 902 may be transmitted in a different order than the example order shown, or the operations performed by the UE 115-h, the network entity 105-d, and/or the repository 902 may be performed in different orders or at different times. Some operations may also be omitted from the process flow 900, and other operations may be added to the process flow 900.

In some examples, one or more of the UE 115-h or the network entity 105-d may support performing one or more procedures 903 (e.g., a model configuration procedures) and/or one or more procedures 913 (e.g., model activation/deactivation procedures), which may include an exchange of one or more messages indicating a set of one or more configurations (or a set of one or more parameters) associated with one or more learning models. The set of one or more configurations (or the set of one or more parameters) associated with the one or more learning models may be stored at a repository 902 (e.g., a database, or the like), which the network entity 105-d may obtain from the repository 902.

At 905, the network entity 105-d may transmit, and the UE 115-h may receive, an RRC configuration message, which may include one or more sets of one or more configurations (or one or more sets of one or more parameters) associated with one or more ML models for AI/ML-enabled RLC status report timing selection. The network entity 105-d may transmit, and the UE 115-h may receive, the RRC configuration message during the procedure 903, which may be an RRC configuration procedure. In some examples, the UE 115-h may configure one or more learning models via L3 signaling and based on the one or more sets of one or more configurations (or the one or more sets of one or more parameters) received in the RRC configuration message.

At 910, the UE 115-h may transmit, and the network entity 105-d may receive, an RRC configuration complete message, for example, based at least in part on the RRC configuration message. The RRC configuration complete message may indicate a completion of the RRC configuration procedure 903 (e.g., the RRC configuration procedure), including configuring of the one or more learning models for AI/ML-enabled RLC status report timing selection, including configuring of the one or more ML models.

In the example of FIG. 9, additionally, or alternatively, at least one configuration of the sets of one or more configurations may be for provisioning network data by the network entity 105-d to the UE 115-h for input to one or more learning models (e.g., AI/ML models). In some examples, the at least one configuration may indicate at least one identifier associated with at least one learning model supporting the network data as input to the least one learning model. In some examples, the UE 115-h may request, the network entity 105-d, to activate or deactivate provisioning of network data as input to the at least one learning model via a MAC-CE. In some examples, the UE 115-h may receive, and the network entity 105-d may transmit, the network data via a unicast transmission and over a physical downlink channel (e.g., a physical downlink control channel (PDCCH), a physical downlink shared channel (PDSCH)). In some other examples, the UE 115-h may receive, and the network entity 105-d may transmit, the network data via a MAC-CE or an RRC message. In other examples, the UE 115-h may receive, and the network entity 105-d may transmit (e.g., broadcast), the network data via system information or a multicast broadcast service (MBS) transmission.

Additionally, or alternatively, at least one configuration of the sets of one or more configurations may be for provisioning, to the network entity 105-d, UE data as input for one or more learning models (e.g., AI/ML models). In some examples, the at least one configuration may indicate at least one identifier associated with at least one learning model supporting the UE data as input to the least one learning model. The network entity 105-d may request, from the UE 115-h, to activate or deactivate provisioning of UE data as input to the at least one learning model via a MAC-CE. In some examples, the UE 115-h may transmit, and the network entity 105-d may receive, UE data via a unicast transmission and over a physical uplink channel (e.g., a physical uplink control channel (PUCCH), a physical uplink shared channel (PUSCH)). In some other examples, the UE 115-h may transmit, and the network entity 105-d may receive, the UE data via a MAC-CE or an RRC message.

At 915, the network entity 105-d may transmit, and the UE 115-h may receive, a signal (also referred to as an activation signal or a deactivation signal) for activating or deactivating one or more learning models for AI/ML-enabled RLC status report timing selection, which may be activated/deactivated during a procedure 913 (e.g., an activation/deactivation procedure of one or more ML models for AI/ML-enabled RLC status report timing selection). In some examples, the network entity 105-d may transmit, and the UE 115-h may receive, via L2 signaling, the signal for activating or deactivating the one or more learning models. For example, the network entity 105-d may transmit, and the UE 115-h may receive, a MAC-CE that activates or deactivates the one or more learning models. In some examples, activating or deactivating the one or more learning models may be based at least in part on a switching event.

Accordingly, one or more of the UE 115-h or the network entity 105-d may be configured to support managing one or more ML models based at least in part on activating or deactivating one or more learning models via MAC-CE, which allows RLC status report timing selection at the UE 115-h. In some aspects, the UE 115-h may support RLC status report timing selection. In such cases, the UE 115-h may use one or more ML models, which may be managed in accordance with the process flow 900, for predicting one or more probabilities that a missing RLC PDU will be received (e.g., that an RLC hole will be filled) at the UE 115-h after one or more corresponding potential expiration times of the timer, an expected latency of an RLC SDU (e.g., indicated by SN) and whether the RLC SDU will arrive at the RLC entity of the UE 115-h after the first expiration time of the timer or after another PDB-related threshold, a probability that the latency of the RLC SDU is within a threshold latency range (e.g., less than a maximum threshold latency, greater than a minimum threshold latency, both), a prediction of a latency distribution among RLC PDUs based on all RLC parameters and events, general predictions about RLC PDU arrival time or timer expiration, or any combination thereof. The UE 115-h may determine an expiration time of the timer, one or more event triggers, or both, based on such ML model predictions.

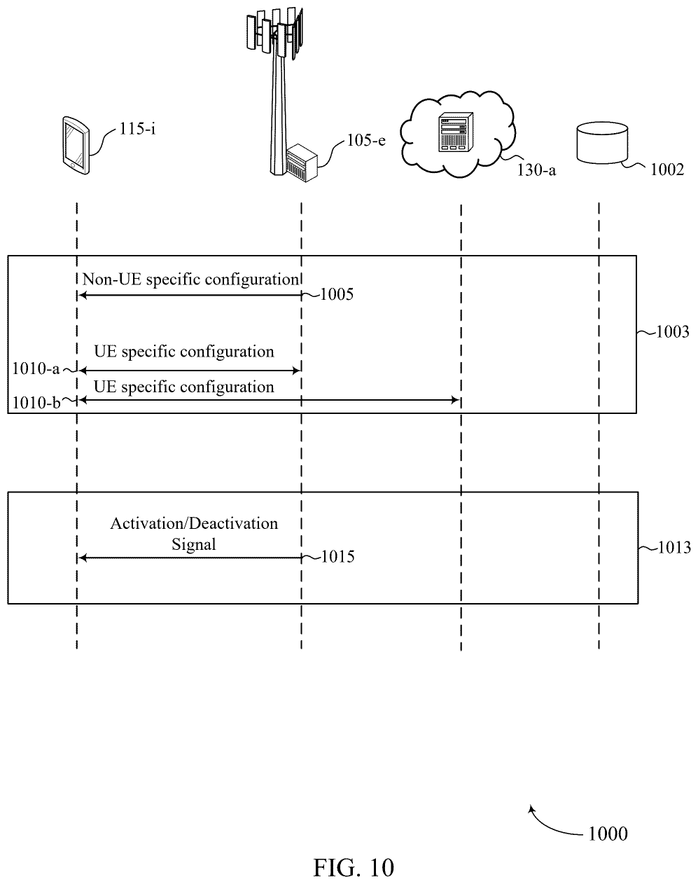

FIG. 10 shows an example of a process flow 1000 that supports RLC status report timing selection in accordance with one or more aspects of the present disclosure. The process flow 1000 may implement aspects of the wireless communications system 100 and the wireless communications system 200, as described with reference to FIGS. 1 and 2, respectively. The process flow 1000 may include a UE 115-i and a network entity 105-c, which may be examples of UEs 115 and network entities 105 as described herein. Additionally, the process flow 1000 may include a repository 1002 (e.g., a database) storing one or more machine learning models, or information regarding the same. the repository 1002 may be an example of a repository 902 described with reference to FIG. 9. In some aspects, the process flow 1000 may include a core network 130-a, which may be an example of the core network 130 described with reference to FIG. 1. In the following description of the process flow 1000, the operations between the UE 115-i, the network entity 105-e, the core network 130-a, and/or the repository 1002 may be transmitted in a different order than the example order shown, or the operations performed by the UE 115-i, the network entity 105-e, the core network 130-a, and/or the repository 1002 may be performed in different orders or at different times. Some operations may also be omitted from the process flow 1000, and other operations may be added to the process flow 1000.

In some examples, one or more of the UE 115-i, the network entity 105-e, or the core network 130-a may support performing one or more procedures 1003 and/or 1013, which may exchange of a set of one or more configurations (or a set of one or more parameters) associated with one or more learning models for AI/ML-enabled RLC status report timing selection. For example, one or more of the UE 115-i, the network entity 105-e, or the core network 130-a may support performing one or more procedures, which may exchange of the set of one or more configurations (or the set of one or more parameters) associated with the one or more learning models based at least in part on a state (e.g., an idle state, an inactivate state) of the UE 115-i. In some examples, one or more of the UE 115-i, the network entity 105-e, or the core network 130-a may support activating or deactivating the one or more learning models for inference during the state of the UE 115-i. For example, one or more of the UE 115-i, the network entity 105-e, or the core network 130-a may support activating or deactivating the one or more learning models to perform an inference (e.g., training) of the one or more learning models and cell selection, cell reselection, RLF recovery, measurement operations, random access channel operations (e.g., beam selection, random access channel occasions (RO), and the like).

At 1005, the network entity 105-e may transmit, and the UE 115-i may receive, a set of one or more non-UE specific configurations. For example, the network entity 105-e may broadcast, and the UE 115-i may receive, system information including the set of one or more non-UE specific configurations. The system information may include a system information block (SIB). The set of one or more non-UE specific configurations may include one or more sets of one or more parameters, which may be associated with a set of one or more learning models and include a set of one or more identifiers associated with the set of one or more learning models, etc.

Additionally, or alternatively, at 1010, the network entity 105-e may transmit, and the UE 115-i may receive, for example, via a unicast transmission, a set of one or more UE specific configurations for RLC status report timing selection, as described herein. For example, the network entity 105-e may transmit, and the UE 115-i may receive, an RRC message including the set of one or more UE specific configurations. The set of one or more UE specific configurations may include one or more sets of one or more parameters, which may be associated with a set of one or more learning models including a set of one or more identifiers associated with the set of one or more learning models. In some examples, the RRC message may be an RRC release message during an RRC release procedure. In some examples, at 1010-a and/or 1010-b, one or more of the UE 115-i, the network entity 105-e, or the core network 130-a (e.g., one or more network functions associated with the core network 130-a) may exchange one or more NAS messages associated with the set of one or more UE specific configurations.

At 1015, the network entity 105-e may transmit, and the UE 115-i may receive, a signal (also referred to as an activation signal or a deactivation signal) for activating or deactivating one or more learning models. In some examples, the network entity 105-e may transmit, and the UE 115-i may receive, the signal for activating or deactivating the one or more learning models. For example, the network entity 105-e may transmit, and the UE 115-i may receive, a MAC-CE that activates or deactivates the one or more learning models and may perform an inference (e.g., training) of the one or more learning models during an idle state or an inactivate state of the UE 115-i. As such, activating or deactivating the one or more learning models may be based at least in part on the idle state or the inactivate state of the UE 115-i.

Accordingly, one or more of the UE 115-i, the network entity 105-e, or the core network 130-a may support activating or deactivating one or more learning models and for inference of the one or more learning models during an idle state or an inactivate state of the UE 115-i. For example, the UE 115-i may support techniques for RLC status report timing selection. In such cases, the UE 115-i may use one or more ML models, which may be managed in accordance with the process flow 1000, for predicting one or more probabilities that a missing RLC PDU will be received (e.g., that an RLC hole will be filled) at the UE 115-i after one or more corresponding potential expiration times of the timer, an expected latency of an RLC SDU (e.g., indicated by SN) and whether the RLC SDU will arrive at the RLC entity of the UE 115-i after the first expiration time of the timer or after another PDB-related threshold, a probability that the latency of the RLC SDU is within a threshold latency range (e.g., less than a maximum threshold latency, greater than a minimum threshold latency, both), a prediction of a latency distribution among RLC PDUs based on all RLC parameters and events, general predictions about RLC PDU arrival time or timer expiration, or any combination thereof. The UE 115-i may determine an expiration time of the timer, one or more event triggers, or both, based on such ML model predictions.

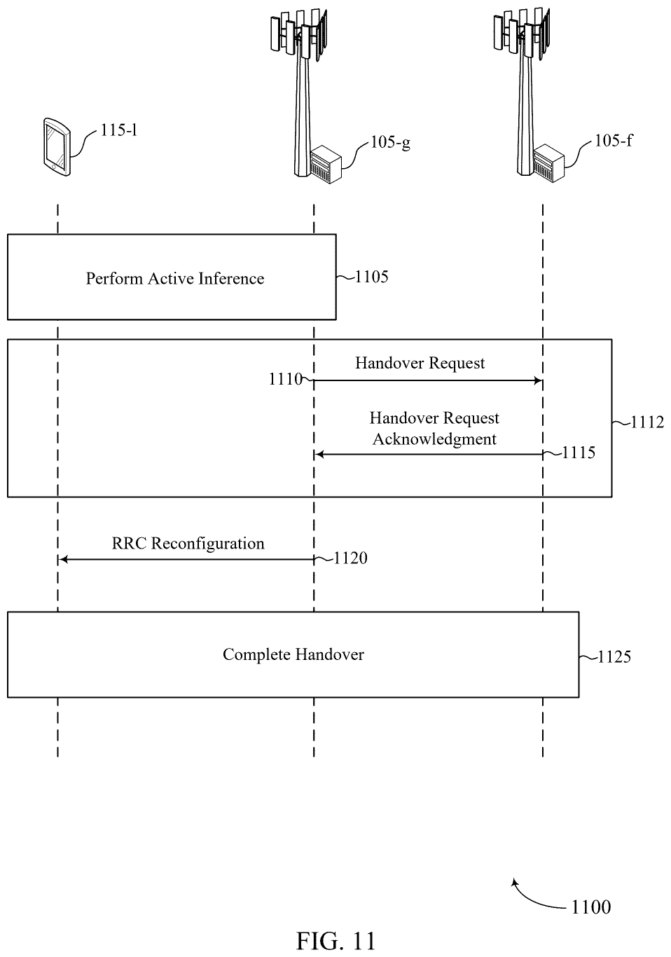

FIG. 11 shows an example of a process flow 1100 that supports RLC status report timing selection in accordance with one or more aspects of the present disclosure. The process flow 1100 may implement aspects of the wireless communications system 100 and the wireless communications system 200, as described with reference to FIGS. 1 and 2, respectively. The process flow 1100 may include a UE 115-1, a network entity 105-g, and a network entity 105-f, which may be examples of UEs 115 and network entities 105 as described herein. In the following description of the process flow 1100, the operations between the UE 115-1, the network entity 105-g, and the network entity 105-f may be transmitted in a different order than the example order shown, or the operations performed by the UE 115-1, the network entity 105-g, and the network entity 105-f may be performed in different orders or at different times. Some operations may also be omitted from the process flow 1100, and other operations may be added to the process flow 1100.

In the example of FIG. 11, one or more of the UE 115-1, the network entity 105-g, and the network entity 105-f may support managing ML models for RLC status report timing selection during a mobility (also referred to as UE mobility) of the UE 115-1. More specifically, one or more of the UE 115-1, the network entity 105-g, and the network entity 105-f may support managing AI/ML functionality associated with the UE 115-1 during a handover procedure, which may include switching (e.g., transferring) a connection of the UE 115-1 from the network entity 105-g (also referred to as a source base station) to the network entity 105-f (also referred to as a target base station) and while maintaining ongoing AI/ML functionality.

At 1105, one or more of the UE 115-1 or the network entity 105-g may perform an active inference (e.g., training) of one or more learning models. The inference (e.g., training) of the one or more learning models may be based at least in part on one or more sets of one or more configurations, including one or more sets of one or more parameters, configured by the network entity 105-g.

At 1110, the network entity 105-g may transmit, and the network entity 105-f may receive, a handover request message, which may include context information (e.g., AI/ML context) associated with the one or more ML models for AI/ML-enabled RLC status report timing selection, which may occur during a handover preparation procedure 1112. At 1115, the network entity 105-f may transmit, and the network entity 105-g may receive, a handover request acknowledgment message during the handover preparation procedure 1112, which may include one or more sets of one or more configurations, including one or more sets of one or more parameters, configured by the network entity 105-f. Put another way, the network entity 105-f may provide a set of one or more AI/ML configurations for the UE 115-1 to apply after being handed over to the network entity 105-f from the network entity 105-g. In some examples, the network entity 105-g may determine the sets of one or more configurations, including the one or more sets of one or more parameters, based at least in part on the context information (e.g., AI/ML context) received from the network entity 105-f. Additionally, or alternatively, the network entity 105-g may determine the sets of one or more configurations, including the one or more sets of one or more parameters, based at least in part on one or more of UE capabilities of the UE 115-1 or network capabilities of the network entity 105-f. In some examples, one or more of the UE 115-1 or the network entity 105-f may support partial or full AI/ML functionality (e.g., enabling of one or more features associated with at least one learning model).

At 1120, the network entity 105-g may transmit, and the UE 115-1 may receive, an RRC reconfiguration message, which may include the sets of one or more configurations, including the one or more sets of one or more parameters, configured by the network entity 105-f. At 1125, one or more of the UE 115-1, the network entity 105-g, or the network entity 105-f may complete the handover procedure.

Accordingly, one or more of the UE 115-1, the network entity 105-g, or the network entity 105-f may support RLC status report timing selection for the UE 115-1 using one or more ML models. For example, the UE 115-1 may support RLC status report timing selection. In such cases, the UE 115-1 may use one or more ML models, which may be managed in accordance with the process flow 1100, for predicting one or more probabilities that a missing RLC PDU will be received (e.g., that an RLC hole will be filled) at the UE 115-1 after one or more corresponding potential expiration times of the timer, an expected latency of an RLC SDU (e.g., indicated by SN) and whether the RLC SDU will arrive at the RLC entity of the UE 115-1 after the first expiration time of the timer or after another PDB-related threshold, a probability that the latency of the RLC SDU is within a threshold latency range (e.g., less than a maximum threshold latency, greater than a minimum threshold latency, both), a prediction of a latency distribution among RLC PDUs based on all RLC parameters and events, general predictions about RLC PDU arrival time or timer expiration, or any combination thereof. The UE 115-1 may determine an expiration time of the timer, one or more event triggers, or both, based on such ML model predictions.

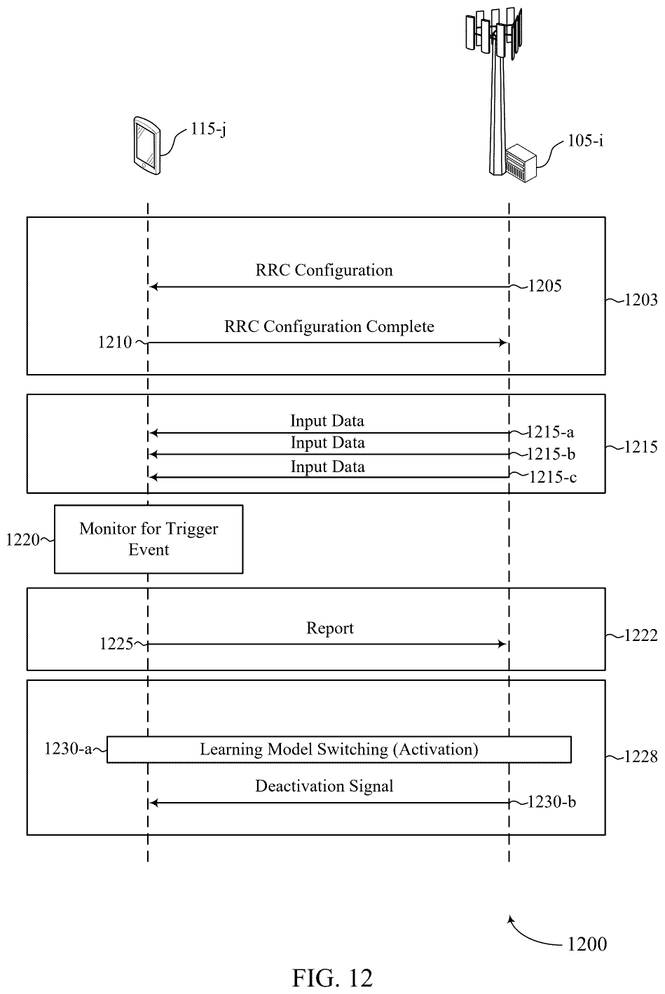

FIG. 12 shows an example of a process flow 1200 that supports RLC status report timing selection in accordance with one or more aspects of the present disclosure. The process flow 1200 may implement aspects of the wireless communications system 100 and the wireless communications system 200, as described with reference to FIGS. 1 and 2, respectively. The process flow 1200 may include a UE 115-j and a network entity 105-i, which may be examples of UEs 115 and network entities 105 as described herein. In the following description of the process flow 1200, the operations between the UE 115-j and the network entity 105-i may be transmitted in a different order than the example order shown, or the operations performed by the UE 115-j and the network entity 105-i may be performed in different orders or at different times. Some operations may also be omitted from the process flow 1200, and other operations may be added to the process flow 1200.

In the example of FIG. 12, one or more of the UE 115-j or the network entity 105-i may support activating and deactivating one or more learning models based at least in part on reporting of feedback associated with the one or more learning models by the UE 115-j.

At 1205, the network entity 105-i may transmit, and the UE 115-j may receive, an RRC message that includes a set of one or more RRC configurations during a procedure 1203 (e.g., an RRC procedure), which may include a set of one or more parameters. In some examples, one or more parameters of the set of one or more parameters may include one or more performance KPIs or one or more system KPIs, or a combination thereof. In some other examples, one or more parameters of the set of one or more parameters may include one or more monitoring events (e.g., thresholds, conditions). In other examples, one or more parameters of the set of one or more parameters may include one or more reporting events, reporting periodicity, etc. At 1210, the UE 115-j may transmit, and the network entity 105-i may receive, an RRC configuration complete message e.g., during the procedure 1203.

At 1215, the network entity 105-i may transmit, and the UE 115-j may receive, input data, which may be input for one or more learning models at the UE 115-j. In some examples, the network entity 105-i may transmit, and the UE 115-j may receive, input data via one or more unicast transmissions. For example, at 1215-a, 1215-b, and 1215-c, the network entity 105-i may transmit, and the UE 115-j may receive, input data via one or more unicast transmissions. In some other examples, the network entity 105-i may broadcast, and the UE 115-j may receive, input data via one or more broadcast transmissions. For example, at 1215-a, 1215-b, and 1215-c, the network entity 105-i may transmit, and the UE 115-j may receive, input data via one or more broadcast transmissions.

At 1220, the UE 115-j may monitor for one or more events (e.g., threshold satisfied, conditions satisfied) associated with the one or more learning models. At 1225, the UE 115-j may transmit, and the network entity 105-i may receive, a report based at least in part on the one or more events, such as a reporting event 1222. The report may indicate the one or more performance KPIs or the one or more system KPIs, or a combination thereof.

At 1230-a, one or more of the UE 115-j or the network entity 105-i may switch between one or more learning models for AI/ML-enabled RLC status report timing selection as described herein, which may be based on one or more events, for example, associated with a procedure 1228 for switching, activation, or deactivation. For example, one or more of the UE 115-j or the network entity 105-i may active at least one learning model of the one or more learning models based at least in part on the reported one or more performance KPIs or the reported one or more system KPIs, or a combination thereof. Additionally, or alternatively, at 1230-b, one or more of the UE 115-j or the network entity 105-i may activate or deactivate at least one learning model of the one or more learning models based at least in part on the reported one or more performance KPIs or the reported one or more system KPIs, or a combination thereof.

Accordingly, one or more of the UE 115-j or the network entity 105-i may support activating and deactivating one or more learning models based at least in part on reported feedback associated with the one or more learning models by the UE 115-j. For example, the UE 115-j may support techniques for RLC status report timing selection. In such cases, the UE 115-j may use one or more ML models, which may be managed in accordance with the process flow 1200, for predicting one or more probabilities that a missing RLC PDU will be received (e.g., that an RLC hole will be filled) at the UE 115-j after one or more corresponding potential expiration times of the timer, an expected latency of an RLC SDU (e.g., indicated by SN) and whether the RLC SDU will arrive at the RLC entity of the UE 115-j after the first expiration time of the timer or after another PDB-related threshold, a probability that the latency of the RLC SDU is within a threshold latency range (e.g., less than a maximum threshold latency, greater than a minimum threshold latency, both), a prediction of a latency distribution among RLC PDUs based on all RLC parameters and events, general predictions about RLC PDU arrival time or timer expiration, or any combination thereof. The UE 115-j may determine an expiration time of the timer, one or more event triggers, or both, based on such ML model predictions.

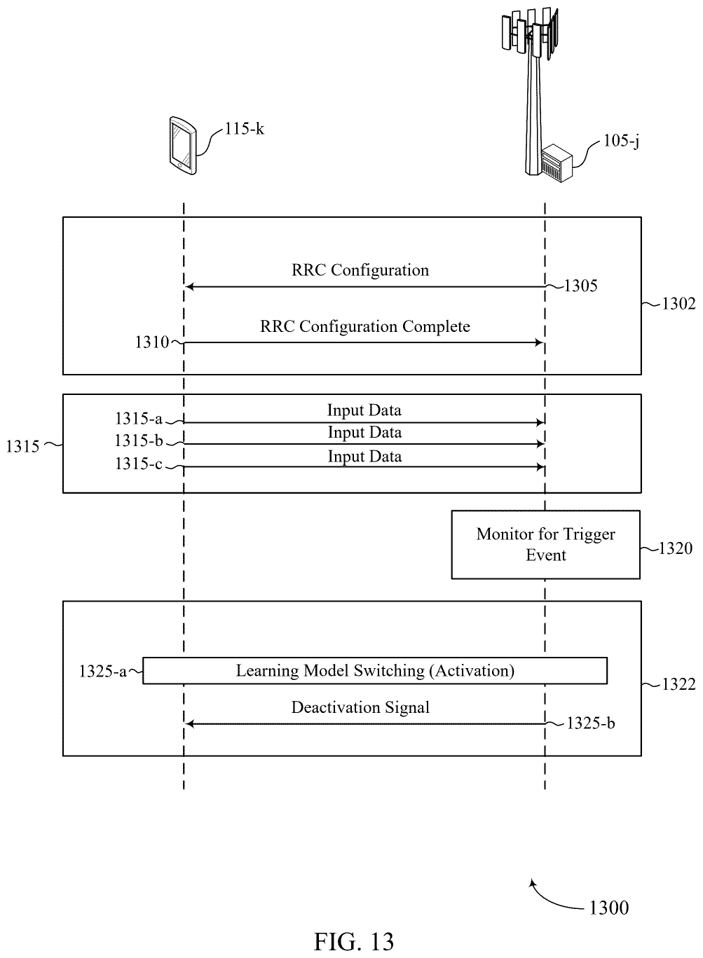

FIG. 13 shows an example of a process flow 1300 that supports RLC status report timing selection in accordance with one or more aspects of the present disclosure. The process flow 1300 may implement aspects of the wireless communications system 100 and the wireless communications system 200, as described with reference to FIGS. 1 and 2, respectively. The process flow 1300 may include a UE 115-k and a network entity 105-j, which may be examples of UEs 115 and network entities 105 as described herein. In the following description of the process flow 1300, the operations between the UE 115-k and the network entity 105-j may be transmitted in a different order than the example order shown, or the operations performed by the UE 115-k and the network entity 105-j may be performed in different orders or at different times. Some operations may also be omitted from the process flow 1300, and other operations may be added to the process flow 1300.

In the example of FIG. 13, one or more of the UE 115-k or the network entity 105-j may support activating and deactivating one or more learning models based at least in part on monitoring by the network entity 105-j of the one or more learning models.

At 1305, the network entity 105-j may transmit, and the UE 115-k may receive, an RRC message that includes set of one or more RRC configurations during a procedure 1302 (e.g., an RRC procedure), which may include a set of one or more parameters. In some examples, one or more parameters of the set of one or more parameters may include one or more performance KPIs or one or more system KPIs, or a combination thereof. At 1310, the UE 115-k may transmit, and the network entity 105-j may receive, an RRC configuration complete message as part of the procedure 1302.

At 1315, the network entity 105-j may receive, and the UE 115-k may transmit, input data, which may be input for one or more learning models at the network entity 105-j. In some examples, the network entity 105-j may receive, and the UE 115-k may transmit, input data via one or more unicast transmissions. For example, at 1315-a, 1315-b, and 1315-c, the network entity 105-j may receive, and the UE 115-k may transmit, input data via one or more unicast transmissions. At 1320, the network entity 105-j may monitor for one or more events (e.g., threshold satisfied, conditions satisfied) associated with the one or more learning models at the network entity 105-j.

At 1325-a, one or more of the UE 115-k or the network entity 105-j may switch between one or more learning models based on one or more events, for example, associated with a procedure 1322 for switching, activation, or deactivation. For instance, one or more of the UE 115-k or the network entity 105-j may active at least one ML model of the one or more ML models based at least in part on the one or more events as described herein. Additionally, or alternatively, at 1325-b, one or more of the UE 115-k or the network entity 105-j may deactivate at least one ML model of the one or more ML models based on the one or more events as described herein. Accordingly, one or more of the UE 115-k or the network entity 105-j may support activating and deactivating one or more learning models for RLC status report timing selection at the UE 115-k based at least in part on monitoring by the network entity 105-j of the one or more learning models. For example, the UE 115-k may support RLC status report timing selection. In such cases, the UE 115-k may use one or more ML models, which may be managed in accordance with the process flow 1300, for predicting one or more probabilities that a missing RLC PDU will be received (e.g., that an RLC hole will be filled) at the UE 115-k after one or more corresponding potential expiration times of the timer, an expected latency of an RLC SDU (e.g., indicated by SN) and whether the RLC SDU will arrive at the RLC entity of the UE 115-k after the first expiration time of the timer or after another PDB-related threshold, a probability that the latency of the RLC SDU is within a threshold latency range (e.g., less than a maximum threshold latency, greater than a minimum threshold latency, both), a prediction of a latency distribution among RLC PDUs based on all RLC parameters and events, general predictions about RLC PDU arrival time or timer expiration, or any combination thereof. The UE 115-k may determine an expiration time of the timer, one or more event triggers, or both, based on such ML model predictions.

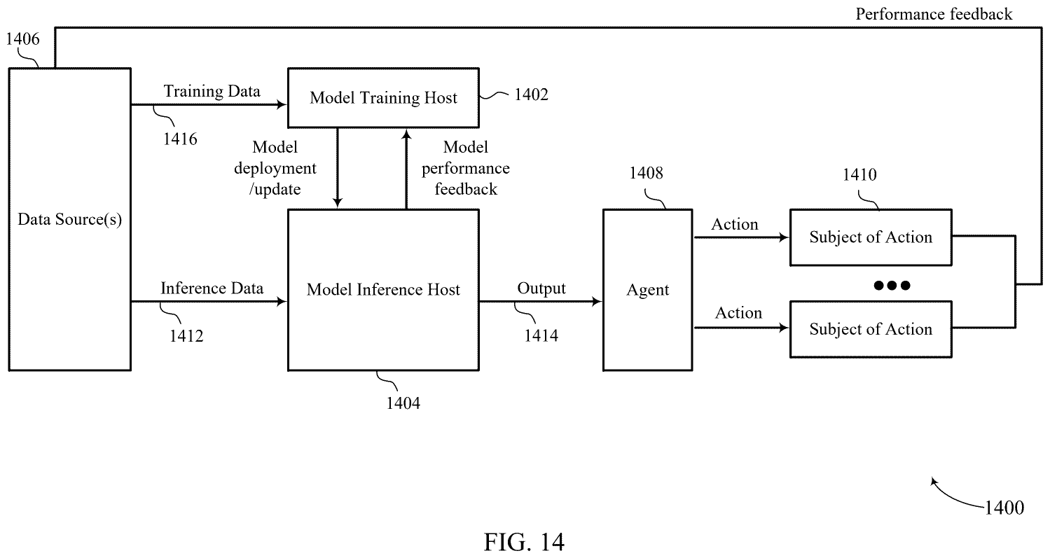

FIG. 14 shows an illustrative block diagram of an example ML architecture 1400 that may be used for wireless communications in accordance with one or more aspects of the present disclosure. The ML architecture 1400 may be used for wireless communications in any of the various implementations, processes, environments, networks, or use cases described herein. As illustrated, architecture 1400 includes multiple logical entities, such as model training host 1402, model inference host 1404, data source(s) 1406, and agent 1408. Model inference host 1404 is configured to run an ML model based on inference data 1412 provided by data source(s) 1406. Model inference host 1404 may produce output 1414, which may include a prediction or inference, such as a discrete or continuous value based on inference data 1412, which may then be provided as input to the agent 1408.

Agent 1408 may represent an element or an entity of a wireless communication system including, for example, a radio access network (RAN), a wireless local area network, a device-to-device (D2D) communications system, etc. As an example, agent 1408 may be a UE (e.g., UE 115 as described herein), a base station (e.g., a base station 140 as described herein), or a disaggregated network entity (such as a CU, a DU, or a RU as described with reference to FIG. 1), an access point, a wireless station, a RIC in a cloud-based RAN, among some examples. Additionally, agent 1408 also may be a type of agent that depends on the type of tasks performed by model inference host 1404, the type of inference data 1412 provided to model inference host 1404, or the type of output 1414 produced by model inference host 1404.

Agent 1408 may perform one or more actions associated with receiving output 1414 from model inference host 1404. For example, if agent 1408 is a UE 115 and the output from model inference host 1404 is associated with RLC status report timing selection, the agent 1408 may perform RLC status report timing selection based on output 1414.

Agent 1408 may indicate the one or more actions performed to at least one subject of action 1410. For example, if the agent 1408 performs RLC status report timing selection based on the output 1414, the agent 1408 may output an indication (e.g., the selected RLC status report timing) to the subject of action 1410 (e.g., a receiving device of the RLC status report).

As another example, agent 1408 may be a UE 115 and output 1414 from model inference host 1404 may include one or more predictions associated with RLC status PDU retransmission, as described herein with respect to at least FIG. 2. For example, the one or more predictions may include one or more probabilities that a missing RLC PDU will be received (e.g., that an RLC hole will be filled) at a UE 115 after one or more corresponding potential expiration times of the timer, an expected latency of an RLC SDU (e.g., indicated by SN) and whether the RLC SDU will arrive at the RLC entity of the UE 115 after the first expiration time of the timer or after another PDB-related threshold, a probability that the latency of the RLC SDU is within a threshold latency range (e.g., less than a maximum threshold latency, greater than a minimum threshold latency, both), a prediction of a latency distribution among RLC PDUs based on all RLC parameters and events, general predictions about RLC PDU arrival time or timer expiration, or any combination thereof. Based on the predictions of the model inference host 1404, agent 1408 may determine an expiration time of the timer, one or more event triggers, or both, based on such ML model predictions. In some cases, agent 1408 and the subject of action 1410 are the same entity (e.g., or are within the same entity).

Data can be collected from data sources 1406, and may be used as training data 1416 for training an ML model, or as inference data 1412 for feeding an ML model inference operation. Data sources 1406 may collect data from various subject of action 1410 entities (such as, the UE 115 or the network entity 105), and provide the collected data to a model training host 1402 for ML model training. For example, after a subject of action 1410 (such as, a UE 115, a network entity 105, one or more protocol layers of the UE 115) obtains selected RLC status report timing from the agent 1408, the subject of action 1410 may provide performance feedback associated with the RLC status report timing to the data sources 1406. The performance feedback may be used by the model training host 1402 for monitoring or evaluating the ML model performance. In some examples, if output 1414 provided to agent 1408 is inaccurate (or the accuracy is below an accuracy threshold), model training host 1402 may provide feedback to model inference host 1404 to modify or retrain the ML model used by model inference host 1404, such as via an ML model deployment/update.

Model training host 1402 may be deployed at the same or a different entity than that in which model inference host 1404 is deployed. For example, in order to offload model training processing, which can impact the performance of model inference host 1404, model training host 1402 may be deployed at a model server.

In some aspects, an ML model is deployed at or on a network entity (such as a base station 140 or a network entity 105) for supporting RLC status report timing selection. In some other aspects, an ML model is deployed at or on a UE (such as UE 115) for supporting RLC status report timing selection. More specifically, a model inference host, such as model inference host 1404 in FIG. 14, may be deployed at or on the UE for generating one or more predictions associated with RLC status PDU retransmission (e.g., as described herein with respect to at least FIG. 2).

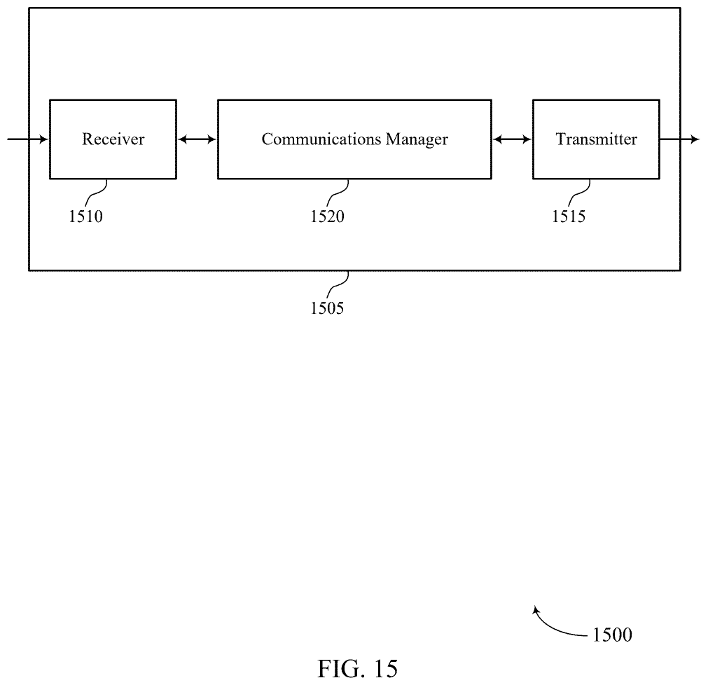

FIG. 15 shows a block diagram 1500 of a device 1505 that supports RLC status report timing selection in accordance with one or more aspects of the present disclosure. The device 1505 may be an example of aspects of a UE 115 as described herein. The device 1505 may include a receiver 1510, a transmitter 1515, and a communications manager 1520. The device 1505, or one or more components of the device 1505 (e.g., the receiver 1510, the transmitter 1515, the communications manager 1520), may include at least one processor, which may be coupled with at least one memory, to, individually or collectively, support or enable the described techniques. Each of these components may be in communication with one another (e.g., via one or more buses).

The receiver 1510 may provide a means for receiving information such as packets, user data, control information, or any combination thereof associated with various information channels (e.g., control channels, data channels, information channels related to RLC status report timing selection). Information may be passed on to other components of the device 1505. The receiver 1510 may utilize a single antenna or a set of multiple antennas.

The transmitter 1515 may provide a means for transmitting signals generated by other components of the device 1505. For example, the transmitter 1515 may transmit information such as packets, user data, control information, or any combination thereof associated with various information channels (e.g., control channels, data channels, information channels related to RLC status report timing selection). In some examples, the transmitter 1515 may be co-located with a receiver 1510 in a transceiver module. The transmitter 1515 may utilize a single antenna or a set of multiple antennas.

The communications manager 1520, the receiver 1510, the transmitter 1515, or various combinations or components thereof may be examples of means for performing various aspects of RLC status report timing selection as described herein. For example, the communications manager 1520, the receiver 1510, the transmitter 1515, or various combinations or components thereof may be capable of performing one or more of the functions described herein.

In some examples, the communications manager 1520, the receiver 1510, the transmitter 1515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1520, the receiver 1510, the transmitter 1515, or various combinations or components thereof may be implemented in code (e.g., as communications management software or firmware) executed by at least one processor (e.g., referred to as a processor-executable code). If implemented in code executed by at least one processor, the functions of the communications manager 1520, the receiver 1510, the transmitter 1515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1520 may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

For example, the communications manager 1520 is capable of, configured to, or operable to support a means for sending a first status PDU associated with an RLC entity of the UE. The communications manager 1520 is capable of, configured to, or operable to support a means for starting, in response to sending the first status PDU, a timer prohibiting one or more additional status PDUs associated with the RLC entity, where the timer has a first expiration time. The communications manager 1520 is capable of, configured to, or operable to support a means for determining a second expiration time for the timer, one or more event triggers, or both, based on one or more predictions for sending the one or more additional status PDUs. The communications manager 1520 is capable of, configured to, or operable to support a means for sending a second status PDU associated with the RLC entity in response to the timer satisfying the second expiration time, an occurrence of the one or more event triggers, or both.

By including or configuring the communications manager 1520 in accordance with examples as described herein, the device 1505 (e.g., at least one processor controlling or otherwise coupled with the receiver 1510, the transmitter 1515, the communications manager 1520, or a combination thereof) may support techniques for more efficient utilization of communication resources. For example, a wireless device (e.g., a UE 115) implementing the techniques described herein may refrain from outputting RLC status PDUs when it is less useful (e.g., based on the ML model predictions), which may reduce transmission of status reports and utilize communication resources more efficiently.

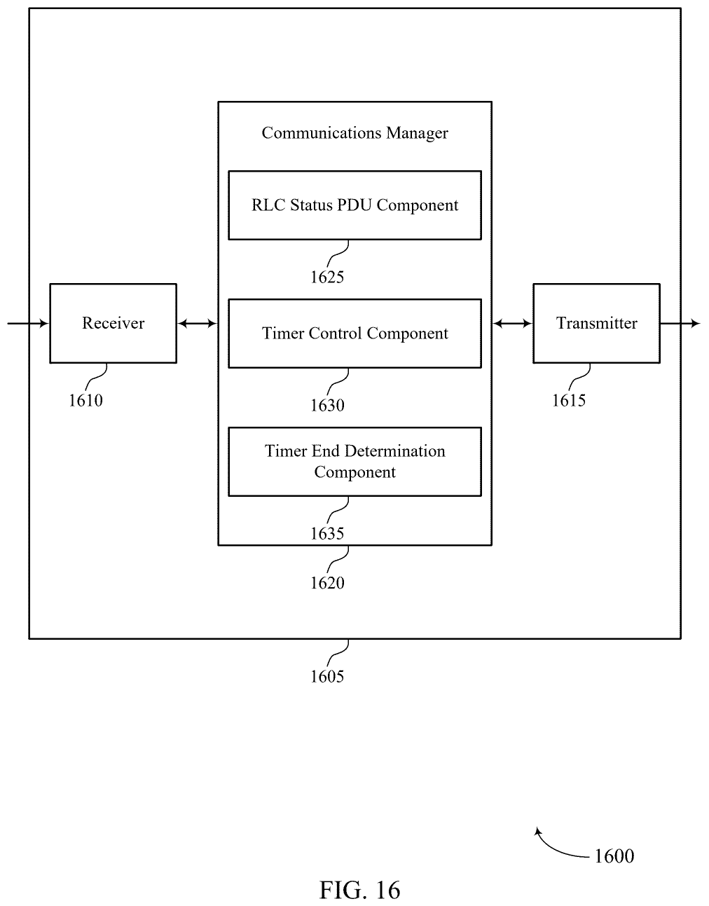

FIG. 16 shows a block diagram 1600 of a device 1605 that supports RLC status report timing selection in accordance with one or more aspects of the present disclosure. The device 1605 may be an example of aspects of a device 1505 or a UE 115 as described herein. The device 1605 may include a receiver 1610, a transmitter 1615, and a communications manager 1620. The device 1605, or one or more components of the device 1605 (e.g., the receiver 1610, the transmitter 1615, the communications manager 1620), may include at least one processor, which may be coupled with at least one memory, to support the described techniques. Each of these components may be in communication with one another (e.g., via one or more buses).

The receiver 1610 may provide a means for receiving information such as packets, user data, control information, or any combination thereof associated with various information channels (e.g., control channels, data channels, information channels related to RLC status report timing selection). Information may be passed on to other components of the device 1605. The receiver 1610 may utilize a single antenna or a set of multiple antennas.

The transmitter 1615 may provide a means for transmitting signals generated by other components of the device 1605. For example, the transmitter 1615 may transmit information such as packets, user data, control information, or any combination thereof associated with various information channels (e.g., control channels, data channels, information channels related to RLC status report timing selection). In some examples, the transmitter 1615 may be co-located with a receiver 1610 in a transceiver module. The transmitter 1615 may utilize a single antenna or a set of multiple antennas.

The device 1605, or various components thereof, may be an example of means for performing various aspects of RLC status report timing selection as described herein. For example, the communications manager 1620 may include an RLC status PDU component 1625, a timer control component 1630, a timer end determination component 1635, or any combination thereof. The communications manager 1620 may be an example of aspects of a communications manager 1520 as described herein. In some examples, the communications manager 1620, or various components thereof, may be configured to perform various operations (e.g., receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

The RLC status PDU component 1625 is capable of, configured to, or operable to support a means for sending a first status PDU associated with an RLC entity of the UE. The timer control component 1630 is capable of, configured to, or operable to support a means for starting, in response to sending the first status PDU, a timer prohibiting one or more additional status PDUs associated with the RLC entity, where the timer has a first expiration time. The timer end determination component 1635 is capable of, configured to, or operable to support a means for determining a second expiration time for the timer, one or more event triggers, or both, based on one or more predictions for sending the one or more additional status PDUs. The RLC status PDU component 1625 is capable of, configured to, or operable to support a means for sending a second status PDU associated with the RLC entity in response to the timer satisfying the second expiration time, an occurrence of the one or more event triggers, or both.

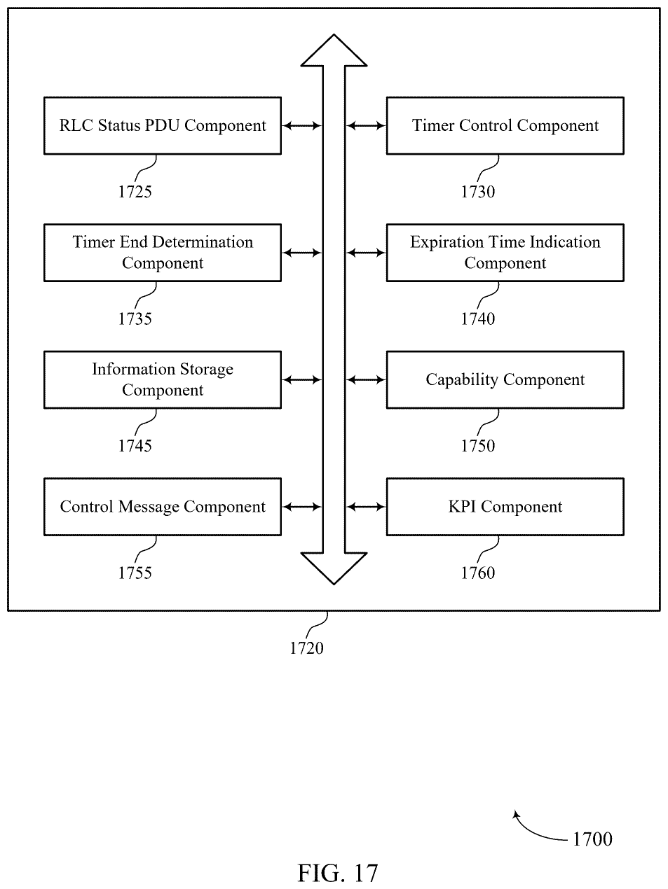

FIG. 17 shows a block diagram 1700 of a communications manager 1720 that supports RLC status report timing selection in accordance with one or more aspects of the present disclosure. The communications manager 1720 may be an example of aspects of a communications manager 1520, a communications manager 1620, or both, as described herein. The communications manager 1720, or various components thereof, may be an example of means for performing various aspects of RLC status report timing selection as described herein. For example, the communications manager 1720 may include an RLC status PDU component 1725, a timer control component 1730, a timer end determination component 1735, an expiration time indication component 1740, an information storage component 1745, a capability component 1750, a control message component 1755, a KPI component 1760, or any combination thereof. Each of these components, or components or subcomponents thereof (e.g., one or more processors, one or more memories), may communicate, directly or indirectly, with one another (e.g., via one or more buses).

The RLC status PDU component 1725 is capable of, configured to, or operable to support a means for sending a first status PDU associated with an RLC entity of the UE. The timer control component 1730 is capable of, configured to, or operable to support a means for starting, in response to sending the first status PDU, a timer prohibiting one or more additional status PDUs associated with the RLC entity, where the timer has a first expiration time. The timer end determination component 1735 is capable of, configured to, or operable to support a means for determining a second expiration time for the timer, one or more event triggers, or both, based on one or more predictions for sending the one or more additional status PDUs. In some examples, the RLC status PDU component 1725 is capable of, configured to, or operable to support a means for sending a second status PDU associated with the RLC entity in response to the timer satisfying the second expiration time, an occurrence of the one or more event triggers, or both.

In some examples, the expiration time indication component 1740 is capable of, configured to, or operable to support a means for transmitting an indication of the second expiration time based on determining the second expiration time.

In some examples, the second status PDU includes the indication of the second expiration time.

In some examples, the indication of the second expiration time includes one or more recommended values corresponding to the second expiration time. In some examples, the one or more recommended values are based on the one or more predictions.

In some examples, to support determining the second expiration time, the timer end determination component 1735 is capable of, configured to, or operable to support a means for selecting a value of the second expiration time based on a range of configured values, where the indication of the second expiration time includes an indication of the selected value.

In some examples, to support determining the second expiration time, the timer end determination component 1735 is capable of, configured to, or operable to support a means for determining a value of the second expiration time based on a quantity of retransmissions associated with one or more PDUs, a latency parameter, the occurrence of the one or more event triggers, or any combination thereof.

In some examples, to support transmitting the indication of the second expiration time, the expiration time indication component 1740 is capable of, configured to, or operable to support a means for transmitting a control message including the indication of the second expiration time, where the control message includes a medium access control (MAC) control element, an RLC control PDU, a radio resource control message, or any combination thereof.

In some examples, the timer control component 1730 is capable of, configured to, or operable to support a means for restarting the timer based on sending the second status PDU in response to the occurrence of the one or more event triggers.

In some examples, the one or more event triggers are based on a predicted loss of a hybrid automatic repeat request message.

In some examples, the one or more event triggers are determined based on a transport block size associated with one or more messages, one or more component carriers used for transmitting the one or more messages, a predicted payload of the one or more messages, a latency parameter associated with the one or more messages, or any combination thereof.

In some examples, the one or more event triggers are associated with a change in performance of one or more links. In some examples, sending the second status PDU in response to the occurrence of the one or more event triggers includes an indication to use a link that is different than the one or more links based on the change in the performance.

In some examples, the information storage component 1745 is capable of, configured to, or operable to support a means for storing a set of information associated with sending the one or more additional status PDUs in response to the timer satisfying the second expiration time, the occurrence of the one or more event triggers, or both, where determining the second expiration time, the one or more event triggers, or both, based on the one or more predictions is in accordance with the set of information.

In some examples, the set of information includes respective values of expiration times for the timer over a first duration, respective event triggers of the one or more event triggers over a second duration, one or more sequence numbers of one or more RLC PDUs corresponding to a quantity of retransmissions, the one or more sequence numbers of one or more RLC PDUs corresponding to a latency, information associated with a quantity of duplicate RLC PDUs, information associated with a quantity of duplicate packet data convergence protocol (PDCP) PDUs, or any combination thereof.

In some examples, the information storage component 1745 (e.g., or one or more other components described herein with respect to FIGS. 16 and 17) is capable of, configured to, or operable to support a means for transmitting a report indicating at least a portion of the set of information based at least in part on storing the set of information associated with sending the one or more additional status protocol data units.

In some examples, sending the second status PDU in response to the timer satisfying the second expiration time, the occurrence of the one or more event triggers, or both, is based on a machine learning model satisfying one or more KPIs. In some examples, the one or more KPIs are associated with a set of statistics indicating a latency for processing of a set of PDUs, a quantity of status PDUs that satisfy a threshold, or any combination thereof.

In some examples, the capability component 1750 is capable of, configured to, or operable to support a means for transmitting a capability message indicating a capability to determine the second expiration time, the one or more event triggers, or both, based on the one or more predictions.

In some examples, the capability message includes an indication of an accuracy of a machine learning model for generating the one or more predictions, an indication of one or more KPI associated with the machine learning model for generating the one or more predictions, or any combination thereof, wherein the one or more key performance indicators indicate one or more throughput parameters supported by the UE, one or more latency parameters supported by the UE, one or more communication performance targets supported by the UE, or any combination thereof.

In some examples, the control message component 1755 is capable of, configured to, or operable to support a means for receiving a control message indicating a configuration of one or more parameters associated with sending the second status PDU in response to the timer satisfying the second expiration time, the occurrence of the one or more event triggers, or both, where sending the second status PDU in response to the timer satisfying the second expiration time, the occurrence of the one or more event triggers, or both, is in accordance with the configuration.

In some examples, the one or more parameters include a minimum value of the timer, a maximum value of the timer, a range of values for the timer corresponding to respective status PDUs of the one or more additional status PDUs, an indication of whether a machine learning model is enabled for the one or more predictions, an indication of whether the machine learning model is enabled for one or more quality of service (QoS) flows, an indication of whether sending the one or more additional status PDUs in response to the one or more event triggers is enabled, an indication of respective event triggers of the one or more event triggers for sending the one or more additional status PDUs, one or more KPIs, a reporting threshold associated with the one or more additional status PDUs, or any combination thereof.

In some examples, the KPI component 1760 is capable of, configured to, or operable to support a means for determining that sending the second status PDU fails to satisfy one or more KPIs, where one or more status PDUs sent after the second status PDU are sent in accordance with the first expiration time of the timer.

In some examples, the KPI component 1760 is capable of, configured to, or operable to support a means for transmitting a message indicating that sending the second status PDU failed to satisfy the one or more KPIs based on determining that sending the second status PDU failed to satisfy the one or more KPIs.

In some examples, the KPI component 1760 is capable of, configured to, or operable to support a means for disabling the one or more predictions for determining the second expiration time for the timer, the one or more event triggers, or both, based on determining that sending the second status PDU failed to satisfy the one or more KPIs.

Additionally, or alternatively, the KPI component 1760 is capable of, configured to, or operable to support a means for one or more of: transmitting a message indicating that sending the second status protocol data unit failed to satisfy the one or more key performance indicators based at least in part on determining that sending the second status protocol data unit failed to satisfy the one or more key performance indicators; and disabling the one or more predictions for determining the second expiration time for the timer, the one or more event triggers, or both, based at least in part on determining that sending the second status protocol data unit failed to satisfy the one or more key performance indicators.

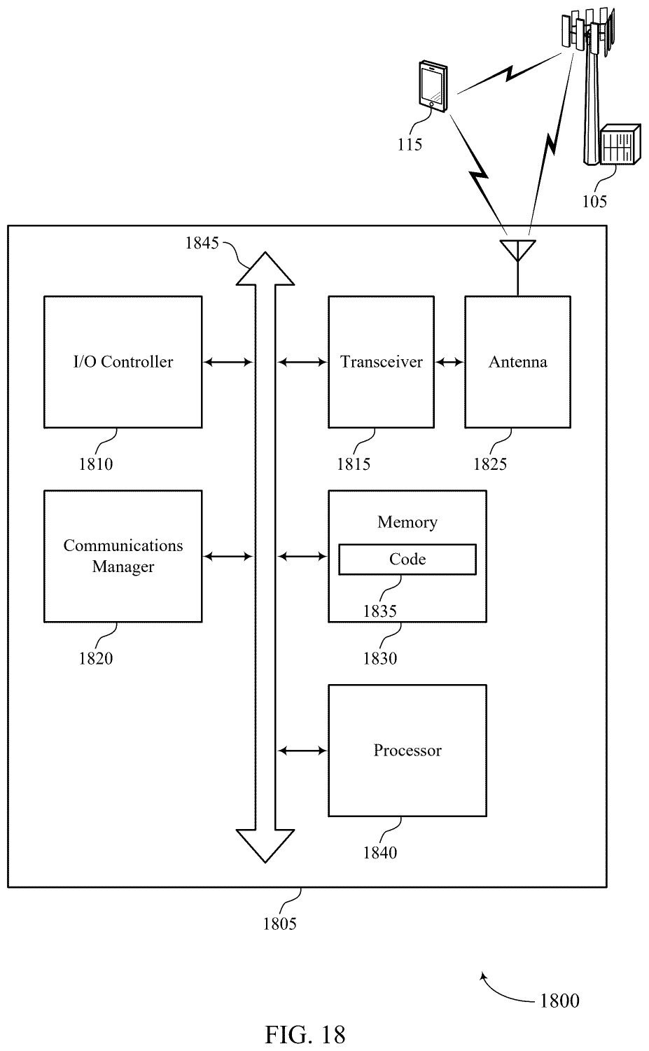

FIG. 18 shows a diagram of a system 1800 including a device 1805 that supports RLC status report timing selection in accordance with one or more aspects of the present disclosure. The device 1805 may be an example of or include components of a device 1505, a device 1605, or a UE 115 as described herein. The device 1805 may communicate (e.g., wirelessly) with one or more other devices (e.g., network entities 105, UEs 115, or a combination thereof). The device 1805 may include components for bi-directional voice and data communications including components for transmitting and receiving communications, such as a communications manager 1820, an input/output (I/O) controller, such as an I/O controller 1810, a transceiver 1815, one or more antennas 1825, at least one memory 1830, code 1835, and at least one processor 1840. These components may be in electronic communication or otherwise coupled (e.g., operatively, communicatively, functionally, electronically, electrically) via one or more buses (e.g., a bus 1845).

The I/O controller 1810 may manage input and output signals for the device 1805. The I/O controller 1810 may also manage peripherals not integrated into the device 1805. In some cases, the I/O controller 1810 may represent a physical connection or port to an external peripheral. In some cases, the I/O controller 1810 may utilize an operating system such as iOS®, ANDROID®, MS-DoS®, MS-WINDOWS®, OS/2®, UNIX®, LINUX®, or another known operating system. Additionally, or alternatively, the I/O controller 1810 may represent or interact with a modem, a keyboard, a mouse, a touchscreen, or a similar device. In some cases, the I/O controller 1810 may be implemented as part of one or more processors, such as the at least one processor 1840. In some cases, a user may interact with the device 1805 via the I/O controller 1810 or via hardware components controlled by the I/O controller 1810.

In some cases, the device 1805 may include a single antenna. However, in some other cases, the device 1805 may have more than one antenna, which may be capable of concurrently transmitting or receiving multiple wireless transmissions. The transceiver 1815 may communicate bi-directionally via the one or more antennas 1825 using wired or wireless links as described herein. For example, the transceiver 1815 may represent a wireless transceiver and may communicate bi-directionally with another wireless transceiver. The transceiver 1815 may also include a modem to modulate the packets, to provide the modulated packets to one or more antennas 1825 for transmission, and to demodulate packets received from the one or more antennas 1825. The transceiver 1815, or the transceiver 1815 and one or more antennas 1825, may be an example of a transmitter 1515, a transmitter 1615, a receiver 1510, a receiver 1610, or any combination thereof or component thereof, as described herein.

The at least one memory 1830 may include random access memory (RAM) and read-only memory (ROM). The at least one memory 1830 may store computer-readable, computer-executable, or processor-executable code, such as the code 1835. The code 1835 may include instructions that, when executed by the at least one processor 1840, cause the device 1805 to perform various functions described herein. The code 1835 may be stored in a non-transitory computer-readable medium such as system memory or another type of memory. In some cases, the code 1835 may not be directly executable by the at least one processor 1840 but may cause a computer (e.g., when compiled and executed) to perform functions described herein. In some cases, the at least one memory 1830 may include, among other things, a basic I/O system (BIOS) which may control basic hardware or software operation such as the interaction with peripheral components or devices.

The at least one processor 1840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1840 may be configured to operate a memory array using a memory controller. In some other cases, a memory controller may be integrated into the at least one processor 1840. The at least one processor 1840 may be configured to execute computer-readable instructions stored in a memory (e.g., the at least one memory 1830) to cause the device 1805 to perform various functions (e.g., functions or tasks supporting RLC status report timing selection). For example, the device 1805 or a component of the device 1805 may include at least one processor 1840 and at least one memory 1830 coupled with or to the at least one processor 1840, the at least one processor 1840 and the at least one memory 1830 configured to perform various functions described herein.

In some examples, the at least one processor 1840 may include multiple processors and the at least one memory 1830 may include multiple memories. One or more of the multiple processors may be coupled with one or more of the multiple memories, which may, individually or collectively, be configured to perform various functions described herein. In some examples, the at least one processor 1840 may be a component of a processing system, which may refer to a system (such as a series) of machines, circuitry (including, for example, one or both of processor circuitry (which may include the at least one processor 1840) and memory circuitry (which may include the at least one memory 1830)), or components, that receives or obtains inputs and processes the inputs to produce, generate, or obtain a set of outputs. The processing system may be configured to perform one or more of the functions described herein. For example, the at least one processor 1840 or a processing system including the at least one processor 1840 may be configured to, configurable to, or operable to cause the device 1805 to perform one or more of the functions described herein. Further, as described herein, being “configured to,” being “configurable to,” and being “operable to” may be used interchangeably and may be associated with a capability, when executing code 1835 (e.g., processor-executable code) stored in the at least one memory 1830 or otherwise, to perform one or more of the functions described herein.

For example, the communications manager 1820 is capable of, configured to, or operable to support a means for sending a first status PDU associated with an RLC entity of the UE. The communications manager 1820 is capable of, configured to, or operable to support a means for starting, in response to sending the first status PDU, a timer prohibiting one or more additional status PDUs associated with the RLC entity, where the timer has a first expiration time. The communications manager 1820 is capable of, configured to, or operable to support a means for determining a second expiration time for the timer, one or more event triggers, or both, based on one or more predictions for sending the one or more additional status PDUs. The communications manager 1820 is capable of, configured to, or operable to support a means for sending a second status PDU associated with the RLC entity in response to the timer satisfying the second expiration time, an occurrence of the one or more event triggers, or both.

By including or configuring the communications manager 1820 in accordance with examples as described herein, the device 1805 may support techniques for reduced latency. For example, a wireless device (e.g., a UE 115) implementing the techniques describes herein may output RLC status PDUs before a timer expires, reducing waiting time and latency for the user.

In some examples, the communications manager 1820 may be configured to perform various operations (e.g., receiving, monitoring, transmitting) using or otherwise in cooperation with the transceiver 1815, the one or more antennas 1825, or any combination thereof. Although the communications manager 1820 is illustrated as a separate component, in some examples, one or more functions described with reference to the communications manager 1820 may be supported by or performed by the at least one processor 1840, the at least one memory 1830, the code 1835, or any combination thereof. For example, the code 1835 may include instructions executable by the at least one processor 1840 to cause the device 1805 to perform various aspects of RLC status report timing selection as described herein, or the at least one processor 1840 and the at least one memory 1830 may be otherwise configured to, individually or collectively, perform or support such operations.

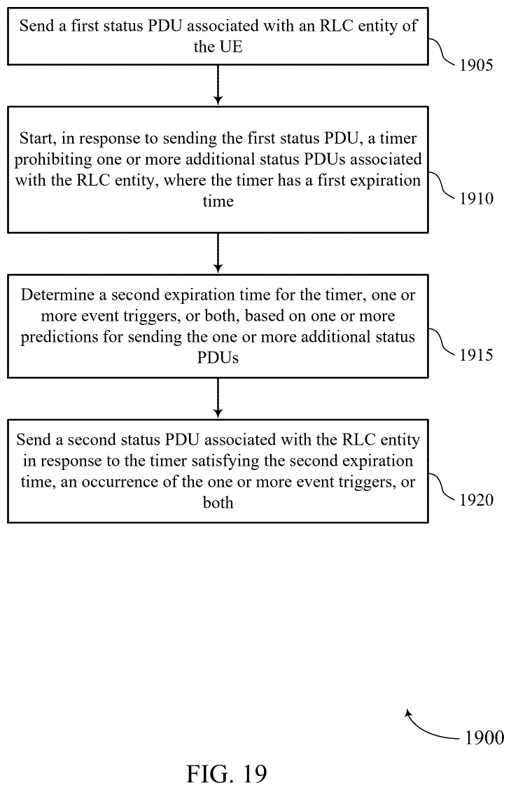

FIG. 19 shows a flowchart illustrating a method 1900 that supports RLC status report timing selection in accordance with one or more aspects of the present components as described herein. For example, the operations of the method 1900 may be performed by a UE 115 as described with reference to FIGS. 1 through 18. In some examples, a UE may execute a set of instructions to control the functional elements of the UE to perform the described functions. Additionally, or alternatively, the UE may perform aspects of the described functions using special-purpose hardware.

At 1905, the method may include sending a first status PDU associated with an RLC entity of the UE. The operations of 1905 may be performed in accordance with examples as disclosed herein. In some examples, aspects of the operations of 1905 may be performed by an RLC status PDU component 1725 as described with reference to FIG. 17.

At 1910, the method may include starting, in response to sending the first status PDU, a timer prohibiting one or more additional status PDUs associated with the RLC entity, where the timer has a first expiration time. The operations of 1910 may be performed in accordance with examples as disclosed herein. In some examples, aspects of the operations of 1910 may be performed by a timer control component 1730 as described with reference to FIG. 17.

At 1915, the method may include determining a second expiration time for the timer, one or more event triggers, or both, based on one or more predictions for sending the one or more additional status PDUs. The operations of 1915 may be performed in accordance with examples as disclosed herein. In some examples, aspects of the operations of 1915 may be performed by a timer end determination component 1735 as described with reference to FIG. 17.

At 1920, the method may include sending a second status PDU associated with the RLC entity in response to the timer satisfying the second expiration time, an occurrence of the one or more event triggers, or both. The operations of 1920 may be performed in accordance with examples as disclosed herein. In some examples, aspects of the operations of 1920 may be performed by an RLC status PDU component 1725 as described with reference to FIG. 17.

The following provides an overview of aspects of the present disclosure:

Aspect 1: A method for wireless communication at a UE comprising: sending a first status protocol data unit associated with a radio link control entity of the UE; starting, in response to sending the first status protocol data unit, a timer prohibiting one or more additional status protocol data units associated with the radio link control entity, wherein the timer has a first expiration time; determining a second expiration time for the timer, one or more event triggers, or both, based at least in part on one or more predictions for sending the one or more additional status protocol data units; and sending a second status protocol data unit associated with the radio link control entity in response to the timer satisfying the second expiration time, an occurrence of the one or more event triggers, or both.

Aspect 2: The method of aspect 1, further comprising: transmitting an indication of the second expiration time based at least in part on determining the second expiration time.

Aspect 3: The method of aspect 2, wherein the second status protocol data unit comprises the indication of the second expiration time.

Aspect 4: The method of any of aspects 2 through 3, wherein the indication of the second expiration time comprises one or more recommended values corresponding to the second expiration time, the one or more recommended values are based at least in part on the one or more predictions.

Aspect 5: The method of any of aspects 2 through 4, wherein determining the second expiration time comprises: selecting a value of the second expiration time based at least in part on a range of configured values, wherein the indication of the second expiration time comprises an indication of the selected value.

Aspect 6: The method of any of aspects 2 through 5, wherein determining the second expiration time comprises: determining a value of the second expiration time based at least in part on a quantity of retransmissions associated with one or more protocol data units, a latency parameter, the occurrence of the one or more event triggers, or any combination thereof.

Aspect 7: The method of any of aspects 2 through 6, wherein transmitting the indication of the second expiration time comprises: transmitting a control message comprising the indication of the second expiration time, wherein the control message comprises a medium access control (MAC) control element, an RLC control protocol data unit, a radio resource control message, or any combination thereof.

Aspect 8: The method of any of aspects 1 through 7, further comprising: restarting the timer based at least in part on sending the second status protocol data unit in response to the occurrence of the one or more event triggers.

Aspect 9: The method of any of aspects 1 through 8, wherein the one or more event triggers are based at least in part on a predicted loss of a hybrid automatic repeat request message.

Aspect 10: The method of any of aspects 1 through 9, wherein the one or more event triggers are determined based at least in part on a transport block size associated with one or more messages, one or more component carriers used for transmitting the one or more messages, a predicted payload of the one or more messages, a latency parameter associated with the one or more messages, or any combination thereof.

Aspect 11: The method of any of aspects 1 through 10, wherein the one or more event triggers are associated with a change in performance of one or more links, sending the second status protocol data unit in response to the occurrence of the one or more event triggers comprises an indication to use a link that is different than the one or more links based at least in part on the change in the performance.

Aspect 12: The method of any of aspects 1 through 11, further comprising: storing a set of information associated with sending the one or more additional status protocol data units in response to the timer satisfying the second expiration time, the occurrence of the one or more event triggers, or both, wherein determining the second expiration time, the one or more event triggers, or both, based at least in part on the one or more predictions is in accordance with the set of information.

Aspect 13: The method of aspect 12, wherein the set of information comprises respective values of expiration times for the timer over a first duration, respective event triggers of the one or more event triggers over a second duration, one or more sequence numbers of one or more radio link control protocol data units corresponding to a quantity of retransmissions, the one or more sequence numbers of one or more radio link control protocol data units corresponding to a latency, information associated with a quantity of duplicate radio link control protocol data units, information associated with a quantity of duplicate packet data convergence protocol (PDCP) protocol data units, or any combination thereof.

Aspect 14: The method of any of aspects 12 through 13, further comprising: transmitting a report indicating at least a portion of the set of information based at least in part on storing the set of information associated with sending the one or more additional status protocol data units.

Aspect 15: The method of any of aspects 1 through 14, wherein sending the second status protocol data unit in response to the timer satisfying the second expiration time, the occurrence of the one or more event triggers, or both, is based at least in part on a machine learning model satisfying one or more key performance indicators, and the one or more key performance indicators are associated with a set of statistics indicating a latency for processing of a set of protocol data units, a quantity of status protocol data units that satisfy a threshold, or any combination thereof.

Aspect 16: The method of any of aspects 1 through 15, further comprising: transmitting a capability message indicating a capability to determine the second expiration time, the one or more event triggers, or both, based at least in part on the one or more predictions.

Aspect 17: The method of aspect 16, wherein the capability message comprises an indication of an accuracy of a machine learning model for generating the one or more predictions, an indication of one or more key performance indicator associated with the machine learning model for generating the one or more predictions, or any combination thereof, the one or more key performance indicators indicate one or more throughput parameters supported by the UE, one or more latency parameters supported by the UE, one or more communication performance targets supported by the UE, or any combination thereof.

Aspect 18: The method of any of aspects 1 through 17, further comprising: receiving a control message indicating a configuration of one or more parameters associated with sending the second status protocol data unit in response to the timer satisfying the second expiration time, the occurrence of the one or more event triggers, or both, wherein sending the second status protocol data unit in response to the timer satisfying the second expiration time, the occurrence of the one or more event triggers, or both, is in accordance with the configuration.

Aspect 19: The method of aspect 18, wherein the one or more parameters comprise a minimum value of the timer, a maximum value of the timer, a range of values for the timer corresponding to respective status protocol data units of the one or more additional status protocol data units, an indication of whether a machine learning model is enabled for the one or more predictions, an indication of whether the machine learning model is enabled for one or more quality of service (QoS) flows, an indication of whether sending the one or more additional status protocol data units in response to the one or more event triggers is enabled, an indication of respective event triggers of the one or more event triggers for sending the one or more additional status protocol data units, one or more key performance indicators, a reporting threshold associated with the one or more additional status protocol data units, or any combination thereof.

Aspect 20: The method of any of aspects 1 through 19 further comprising: determining that sending the second status protocol data unit fails to satisfy one or more key performance indicators, wherein one or more status protocol data units sent after the second status protocol data unit are sent in accordance with the first expiration time of the timer.

Aspect 21: The method of aspect 20, further comprising: transmitting a message indicating that sending the second status protocol data unit failed to satisfy the one or more key performance indicators based at least in part on determining that sending the second status protocol data unit failed to satisfy the one or more key performance indicators.

Aspect 22: The method of any of aspects 20 through 21, further comprising: disabling the one or more predictions for determining the second expiration time for the timer, the one or more event triggers, or both, based at least in part on determining that sending the second status protocol data unit failed to satisfy the one or more key performance indicators.

Aspect 23: An apparatus comprising one or more memories storing processor-executable code, and one or more processors coupled with the one or more memories and individually or collectively operable to execute the code to cause the apparatus to perform a method of any of aspects 1 through 22.

Aspect 24: An apparatus comprising at least one means for performing a method of any of aspects 1 through 22.

Aspect 25: A non-transitory computer-readable medium storing code the code comprising instructions executable by one or more processors to perform a method of any of aspects 1 through 22.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
one or more memories storing processor-executable code; and
one or more processors coupled with the one or more memories and individually or collectively operable to execute the code to cause the apparatus to:
send a first status protocol data unit associated with a radio link control entity of a user equipment (UE);
start, in response to sending the first status protocol data unit, a timer prohibiting one or more additional status protocol data units associated with the radio link control entity, wherein the timer has a first expiration time;
determine a second expiration time for the timer, one or more event triggers, or both, based at least in part on one or more predictions for sending the one or more additional status protocol data units; and
send a second status protocol data unit associated with the radio link control entity in response to the timer satisfying the second expiration time, an occurrence of the one or more event triggers, or both.

2. The apparatus of claim 1, wherein the one or more processors are individually or collectively further operable to execute the code to cause the apparatus to:
transmit an indication of the second expiration time based at least in part on determining the second expiration time.

3. The apparatus of claim 2, wherein the second status protocol data unit comprises the indication of the second expiration time.

4. The apparatus of claim 2, wherein the indication of the second expiration time comprises one or more recommended values corresponding to the second expiration time, and wherein the one or more recommended values are based at least in part on the one or more predictions.

5. The apparatus of claim 2, wherein, to determine the second expiration time, the one or more processors are individually or collectively operable to execute the code to cause the apparatus to:
select a value of the second expiration time based at least in part on a range of configured values, wherein the indication of the second expiration time comprises an indication of the selected value.

6. The apparatus of claim 2, wherein, to determine the second expiration time, the one or more processors are individually or collectively operable to execute the code to cause the apparatus to:
determine a value of the second expiration time based at least in part on a quantity of retransmissions associated with one or more protocol data units, a latency parameter, the occurrence of the one or more event triggers, or any combination thereof.

7. The apparatus of claim 2, wherein, to transmit the indication of the second expiration time, the one or more processors are individually or collectively operable to execute the code to cause the apparatus to:
transmit a control message comprising the indication of the second expiration time, wherein the control message comprises a medium access control (MAC) control element, a radio link control (RLC) control protocol data unit, a radio resource control message, or any combination thereof.

8. The apparatus of claim 1, wherein the one or more processors are individually or collectively further operable to execute the code to cause the apparatus to:
restart the timer based at least in part on sending the second status protocol data unit in response to the occurrence of the one or more event triggers.

9. The apparatus of claim 1, wherein the one or more event triggers are based at least in part on a predicted loss of a hybrid automatic repeat request message.

10. The apparatus of claim 1, wherein the one or more event triggers are determined based at least in part on a transport block size associated with one or more messages, one or more component carriers used for transmitting the one or more messages, a predicted payload of the one or more messages, a latency parameter associated with the one or more messages, or any combination thereof.

11. The apparatus of claim 1, wherein the one or more event triggers are associated with a change in performance of one or more links, and wherein sending the second status protocol data unit in response to the occurrence of the one or more event triggers comprises an indication to use a link that is different than the one or more links based at least in part on the change in the performance.

12. The apparatus of claim 1, wherein the one or more processors are individually or collectively further operable to execute the code to cause the apparatus to:
store a set of information associated with sending the one or more additional status protocol data units in response to the timer satisfying the second expiration time, the occurrence of the one or more event triggers, or both, wherein determining the second expiration time, the one or more event triggers, or both, is based at least in part on the one or more predictions is in accordance with the set of information.

13. The apparatus of claim 12, wherein the one or more processors are individually or collectively further operable to execute the code to cause the apparatus to:
transmit a report indicating at least a portion of the set of information based at least in part on storing the set of information associated with sending the one or more additional status protocol data units.

14. The apparatus of claim 1, wherein sending the second status protocol data unit in response to the timer satisfying the second expiration time, the occurrence of the one or more event triggers, or both, is based at least in part on a machine learning model satisfying one or more key performance indicators, and wherein the one or more key performance indicators are associated with a set of statistics indicating a latency for processing of a set of protocol data units, a quantity of status protocol data units that satisfy a threshold, or any combination thereof.

15. The apparatus of claim 1, wherein the one or more processors are individually or collectively further operable to execute the code to cause the apparatus to:
transmit a capability message indicating a capability to determine the second expiration time, the one or more event triggers, or both, based at least in part on the one or more predictions.

16. The apparatus of claim 1, wherein the one or more processors are individually or collectively further operable to execute the code to cause the apparatus to:
receive a control message indicating a configuration of one or more parameters associated with sending the second status protocol data unit in response to the timer satisfying the second expiration time, the occurrence of the one or more event triggers, or both, wherein sending the second status protocol data unit in response to the timer satisfying the second expiration time, the occurrence of the one or more event triggers, or both, is in accordance with the configuration.

17. The apparatus of claim 16, wherein the one or more parameters comprise a minimum value of the timer, a maximum value of the timer, a range of values for the timer corresponding to respective status protocol data units of the one or more additional status protocol data units, an indication of whether a machine learning model is enabled for the one or more predictions, an indication of whether the machine learning model is enabled for one or more quality of service (QoS) flows, an indication of whether sending the one or more additional status protocol data units in response to the one or more event triggers is enabled, an indication of respective event triggers of the one or more event triggers for sending the one or more additional status protocol data units, one or more key performance indicators, a reporting threshold associated with the one or more additional status protocol data units, or any combination thereof.

18. The apparatus of claim 1, wherein the one or more processors are individually or collectively further operable to execute the code to cause the apparatus to:
determine that sending the second status protocol data unit fails to satisfy one or more key performance indicators, wherein one or more status protocol data units sent after the second status protocol data unit are sent in accordance with the first expiration time of the timer; and one or more of:
transmit a message indicating that sending the second status protocol data unit failed to satisfy the one or more key performance indicators based at least in part on determining that sending the second status protocol data unit failed to satisfy the one or more key performance indicators; and
disable the one or more predictions for determining the second expiration time for the timer, the one or more event triggers, or both, based at least in part on determining that sending the second status protocol data unit failed to satisfy the one or more key performance indicators.

19. A method for wireless communication at a user equipment (UE) comprising:
sending a first status protocol data unit associated with a radio link control entity of the UE;
starting, in response to sending the first status protocol data unit, a timer prohibiting one or more additional status protocol data units associated with the radio link control entity, wherein the timer has a first expiration time;
determining a second expiration time for the timer, one or more event triggers, or both, based at least in part on one or more predictions for sending the one or more additional status protocol data units; and
sending a second status protocol data unit associated with the radio link control entity in response to the timer satisfying the second expiration time, an occurrence of the one or more event triggers, or both.

20. A non-transitory computer-readable medium storing code, the code comprising instructions executable by one or more processors to:
send a first status protocol data unit associated with a radio link control entity of a user equipment (UE);
start, in response to sending the first status protocol data unit, a timer prohibiting one or more additional status protocol data units associated with the radio link control entity, wherein the timer has a first expiration time;
determine a second expiration time for the timer, one or more event triggers, or both, based at least in part on one or more predictions for sending the one or more additional status protocol data units; and
send a second status protocol data unit associated with the radio link control entity in response to the timer satisfying the second expiration time, an occurrence of the one or more event triggers, or both.
